(19) United States
(12) Patent Application Publication
(10) Pub. No.: US 2006/0288021 A1
(43) Pub. Date: Dec. 21, 2006

(54) Information processor, schema definition method and program

(76) Inventor: Junichi Kojima, Hyougo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/409,214

(22) Filed: Apr. 24, 2006

(30) Foreign Application Priority Data
Jun. 20, 2005 (JP) 2005-179434

(51) Int. Cl. G06F 7/00; G06F 17/00

(52) U.S. Cl. 707/100; 715/513

(57) ABSTRACT

It is an object of the present invention to provide an information processor, a schema definition method and program with which it is made possible to generate a schema definition of a relational database and a XML-data schema definition all together. The main part of the present invention is an information processor comprising: an element information storage unit which stores: an element name to identify each of elements which constitute tree-structured data, parent-element identification information for use in identifying a parent element which is a parent of the element, and key information to indicate whether or not the element is a primary key to identify the parent element when the data is managed in a relational database, associating each other; a XML-data schema generation unit which generates a XML-data schema, describing a schema definition for XML to define the data structure, based on the element name and the parent-element identification information; and a RDB schema generation unit which generates a RDB schema, describing a schema definition for a relational database to define the data structure of the data, based on the element name, the parent-element identification information, and the key information.

### FIELD OF THE INVENTION

The present invention relates to an information processor, a schema definition method and program.

### BACKGROUND OF THE INVENTION

The XML (extensible Markup Language) format has become increasingly common for creating data that are expected to be exchanged among information systems. Meanwhile, management of data in information systems is mainly relied upon relational database systems. There has been developed a method for managing tree-structured XML data in a relational database system which is normally supposed to handle tabular data (for example, JP, 2003-271443, A).

Recently, the standardization of schema languages which are used in defining a structure of XML data has been advancing, and it has become possible to strictly define a structure of XML data with the schema language.

However, XML-data schema language is presupposed to define data that have a tree structure as a whole, and is not adapted to define such data as structure consisting plural tables and relations among the tables, unlike relational database. Therefore, conventionally, relational database schemas have been required to be defined separately from XML schema definitions, taking double labor and time.

### SUMMARY OF THE INVENTION

The present invention has been contrived in consideration of the above-mentioned circumstance. It is an object of the present invention to provide an information processor, a schema definition method and program with which it is made possible to generate a schema definition of a relational database and a XML-data schema definition all together.

The main part of the present invention to solve the above-mentioned problem is an information processor comprising:
an element information storage unit which stores:
   an element name to identify each of elements which constitute tree structured-data,
   parent-element identification information for use in identifying a parent element which is a parent of the element, and
   key information to indicate whether or not the element is a primary key to identify the parent element when the data is managed in a relational database, associating each other;
a XML-data schema generation unit which generates a XML-data schema, describing a schema definition for XML to define a structure of the data, based on the element name and the parent-element identification information; and
a RDB schema generation unit which generates a RDB schema, describing a schema definition for a relational database to define the structure of the data, based on the element name, the parent-element identification information, and the key information.
   According to the present invention, it is possible to generate the relational database schema definition and the XML-data schema definition all together.

### BIREF DESCRIPTION OF THE DRAWINGS

FIG. 1 shows a hardware configuration of an information processor 10;

FIG. 2 shows a software configuration of the information processor 10;

FIG. 3 shows a configuration of element management information stored in an element management database 31;

FIG. 4 shows a configuration of attribute management information stored in an attribute management database 32;

FIG. 5 shows a configuration of default value management information stored in a default value management database 33;

FIG. 6 shows a configuration of type information stored on a type information database 34;

FIG. 7 shows an example of a screen 200 through which a data input unit 11 receives data definition inputs;

FIG. 8 is a flow chart showing a process of registering the management information in the databases by the data input unit 11;

FIG. 9 is a flow chart showing a process of registering the element management information;

FIG. 10 shows a configuration of a segment working table 41 containing data for use in the process shown in FIG. 9;

FIG. 11 is a flow chart showing a process of creating a RDB schema definition by a RDB schema generation unit 12;

FIG. 12 is an example of the RDB schema definition generated by the RDB schema generation unit 12;

FIG. 13 is a flow chart showing a process of creating a XML-data schema definition by a XML-data schema generation unit 13;

FIG. 14 shows a configuration of a definition data management table 42 for use in the process shown in FIG. 13;

FIG. 15 shows a configuration of an element name conversion table 43 for use in the process shown in FIG. 13;

FIG. 16 is a flow chart showing a process of creating an element/attribute data type definition;

FIG. 17 is a flow chart showing a process of creating an attribute group definition;

FIG. 18 is a flow chart showing a process of creating an element definition;

FIG. 19 is a flow chart showing a process of creating tags;

FIG. 20 shows an example of a XML-data schema definition generated by the XML-data schema generation unit 13;

FIG. 21 is a flow chart showing a process of reading the XML-data schema definition by a XML-data schema input unit 14;

FIG. 22 is a flow chart showing a process of extracting definition data;

FIG. 23 shows a configuration of a text array 44 for use in the process shown in FIG. 22;

FIG. 24 is a flow chart showing a process of analyzing a segment definition;

FIG. 25 shows a configuration of an element working table 45 for use in the process shown in FIG. 24;

FIG. 26 is a flow chart showing a process of analyzing a key element definition;

FIG. 27 is a flow chart showing a process of analyzing a definition about elements in tree-structured data;

FIG. 28 is a flow chart showing a process of sorting records on the element working table 45 in the depth-first order;

FIG. 29 is a flow chart showing a process of selecting the segment;

FIG. 30 is a flow chart showing a process of merging the segments;

FIG. 31 is a flow chart showing a process of after merging;

FIG. 32 is a flow chart showing a process of analyzing the element definition;

FIG. 33 is a flow chart showing a process of analyzing the element type definition;

FIG. 34 is a flow chart showing a process of analyzing the attribute group definition;

FIG. 35 is a flow chart showing a process of extracting attributes in an attribute group;

FIG. 36 is a flow chart showing a process of registering the default value management information;

FIG. 37 shows a configuration of a working table 46 for use in the process shown in FIG. 36.

### DETAILED DESCRIPTION OF A PREFERRED EMBODIMENT

In the following, an information processor 10 is described as an embodiment of the present invention, with reference to the accompanying drawings. In the present embodiment, a commonly used computer is assumed to be adopted as the information processor 10.

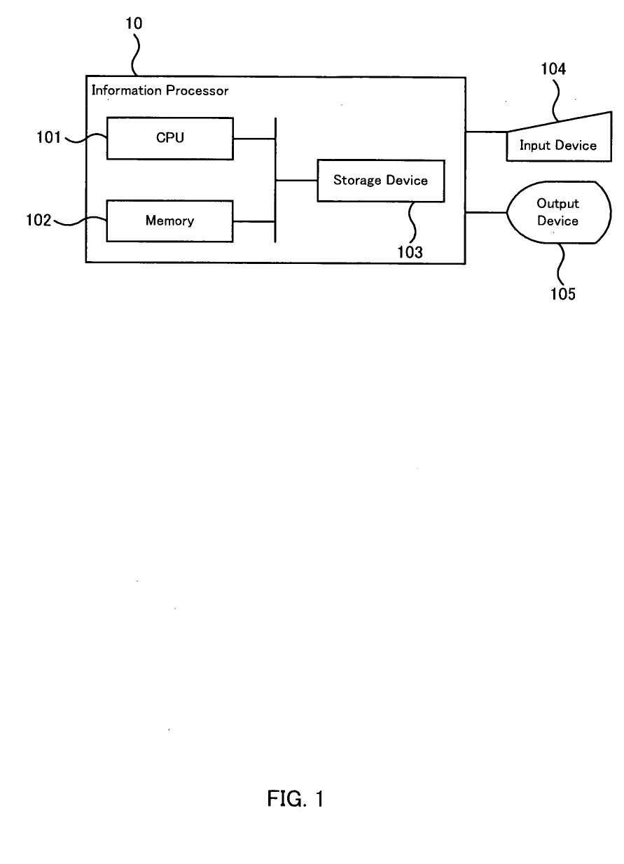

FIG. 1 shows a hardware configuration of the information processor 10. As shown in FIG. 1, the information processor 10 according to the present embodiment comprises a CPU 101, a memory 102, a storage device 103, an input device 104, and an output device 105. The storage device 103 is responsible for holding programs and data. For example, a hard disk drive or a CD-ROM drive is used for it. The CPU 101 reads out the programs and data stored on the storage device 103 and executes them to realize various functions. The input device 104 receives data inputs by users. For example, a keyboard or a mouse is used for it. The output device 105 shows output data. For example, a display is used for it.

The information processor 10 of the present embodiment receives user's inputs on name/data type definitions with respect to elements which consist data having a tree structure (hereinafter referred to as tree-structured data), and generates data in which a definition of relational database schema (hereinafter referred to as RDB schema) is described and data in which a definition of XML data schema (hereinafter referred to as XML-data schema) is described. Incidentally, in the present embodiment, the RDB schema is described in accordance with the SQL (Structured Query Language) language and the XML-data schema is described in accordance with the XML Schema or DTD (Document Type Definition) language.

==Software==

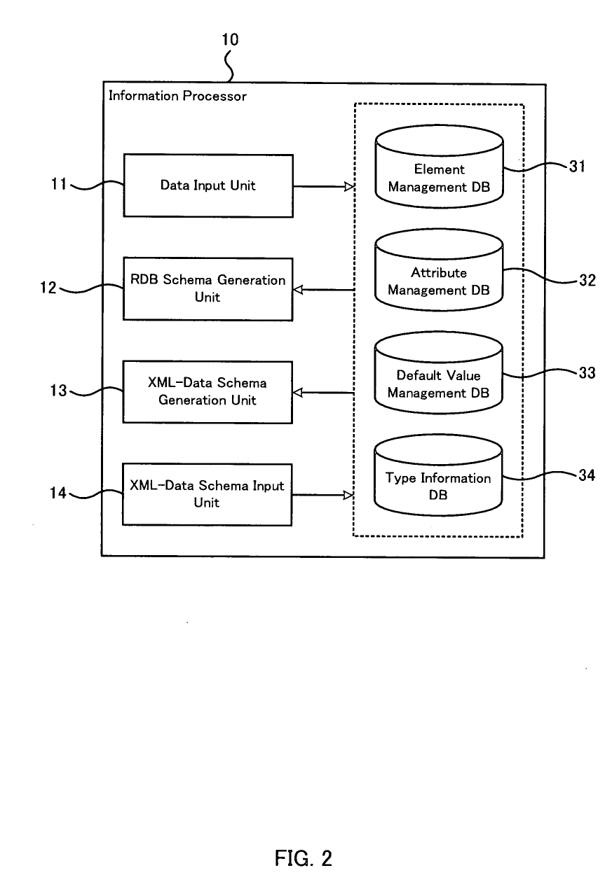

FIG. 2 shows a software configuration of the information processor 10. As shown in FIG. 2, the information processor 10 comprises a data input unit 11, a RDB schema generation unit 12, a XML-data schema generation unit 13, a XML-data schema input unit 14, an element management database 31, an attribute management database 32, a default value management database 33, and a type information database 34.

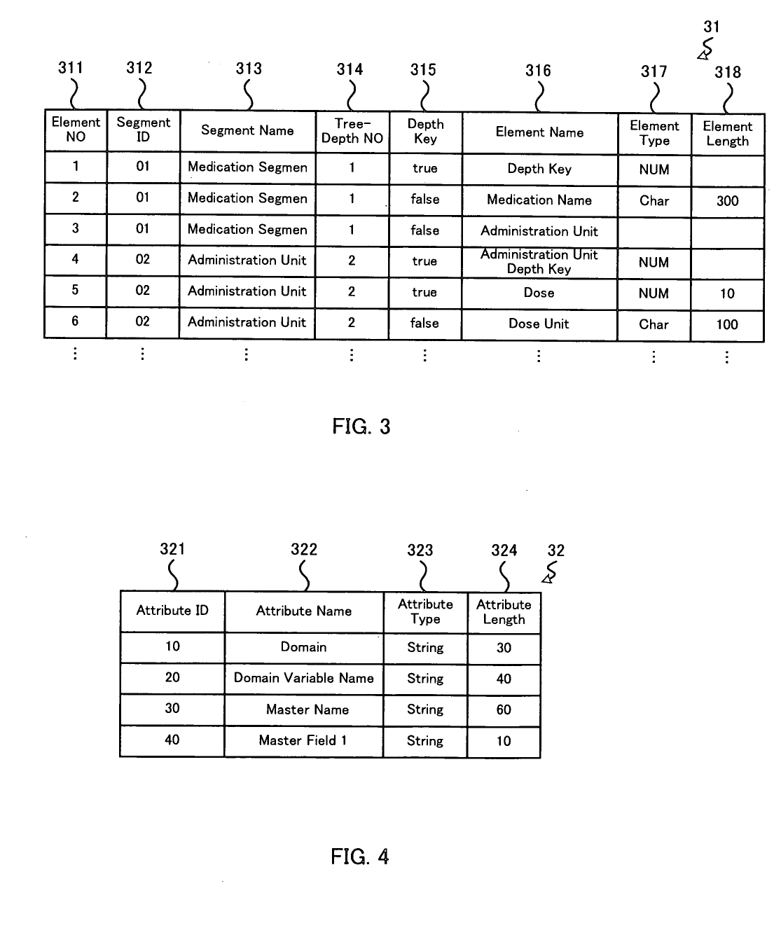

The element management database 31 stores information regarding elements included in the tree-structured data (hereinafter referred to as element management information). FIG. 3 shows a configuration of the element management information stored in the element management database 31. As shown in FIG. 3, the element management information comprises an element NO 311, a segment ID 312, a segment name 313, a tree-depth NO 314, a depth key 315, an element name 316, an element type 317, and an element length 318. The element NO 311 is identification information of the element management information. In the present embodiment, the element NO 311 is assigned in accordance with the depth-first order within tree structure. The segment ID 312 is information to identify a group of children to the same element (hereinafter referred to as segment) in tree structure. In the present embodiment, the segment ID 312 is assigned to elements having children, in accordance with the depth-first order within tree structure. The tree-depth NO 314 is information indicating how far depth an element is in. Incidentally, the said element NO 311 and tree-depth NO 314 function as parent-element identification information in the present invention. The depth key 315 (functions as key information in the present invention) is information indicating whether or not an element is an identification key of a segment in the depth where the segment is. “True” or “False” is set in the depth key 315. As described later on, in the present embodiment, a table is created for every segment and the element with the depth key 315 set as “True” is treated as a primary key of that table in a schema definition of a relational database. The element type 317 and the element depth 318 are information indicating data type and data length of an element respectively.

The attribute management database 32 stores information regarding attributes of the elements (hereinafter referred to as attribute management information). FIG. 4 shows a configuration of the attribute management information stored in the attribute management database 32. As shown in FIG. 4, the attribute management information comprises an attribute ID 321, an attribute name 322, an attribute type 323, and an attribute length 324. The attribute ID 321 is identification information of an attribute. The attribute type 323 and attribute length 324 indicate data type and length of an attribute value respectively.

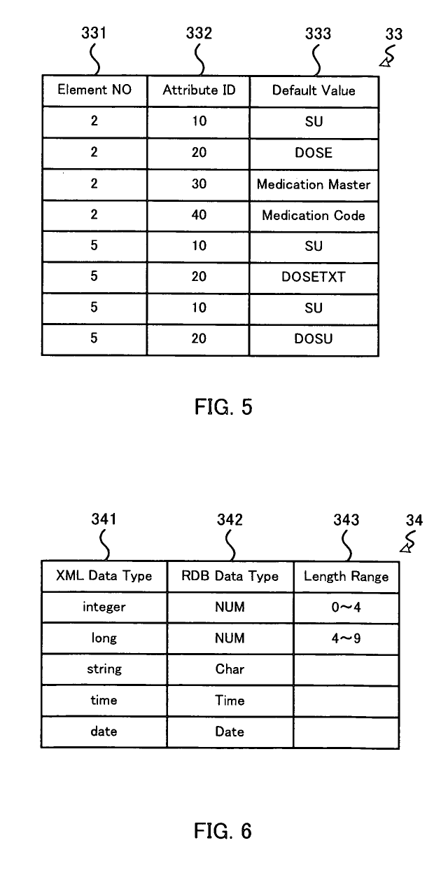

The default value management database 33 manages an attribute default value with respect to an attribute which an element may have, associating the value with the element NO. FIG. 5 shows a configuration of information stored in the default value management database 33 (hereinafter referred to as default value management information). As shown in FIG. 5, the default value management information comprises an element NO 331, an attribute ID 332, and a default value 333 of an attribute.

The type information database 34 stores a data type for use in defining XML-data schema (hereinafter referred to as XML data type), and a data type for use in defining RDB schema (hereinafter referred to as RDB data type). FIG. 6 shows a configuration of information stored in the type information database 34 (hereinafter referred to as type information). As shown in FIG. 6, the type information comprises a XML data type 341, a RDB data type 342, and a length range 343. The length range 343 is information indicating a range of possible data length which an element or an attribute may have. For example, taking a case of defining type for an integer number, only one type “NUM” is available for the integer number in the RDB data type 342 while two types “integer” and “long” are provided in the XML-data type 341. With data length specified, a data type generation unit 30 can determine which one of the two types should be used when defining XML-data schema.

The data input unit 11 (functions as an element information registration unit in the present invention) is responsible for receiving inputs on data definition and registering them in the above-mentioned databases. The RDB schema generation unit 12 generates a RDB schema based on information stored in the databases. The XML-data schema generation unit 13 generates a XML-data schema based on information stored in the databases. The XML-data schema input unit 14 receives inputs on XML-data schema, and registers a definition of tree-structured data in the databases based on the received XML-data schema.

Now, the functions of these units are described in detail.

==Data Input Unit 11==

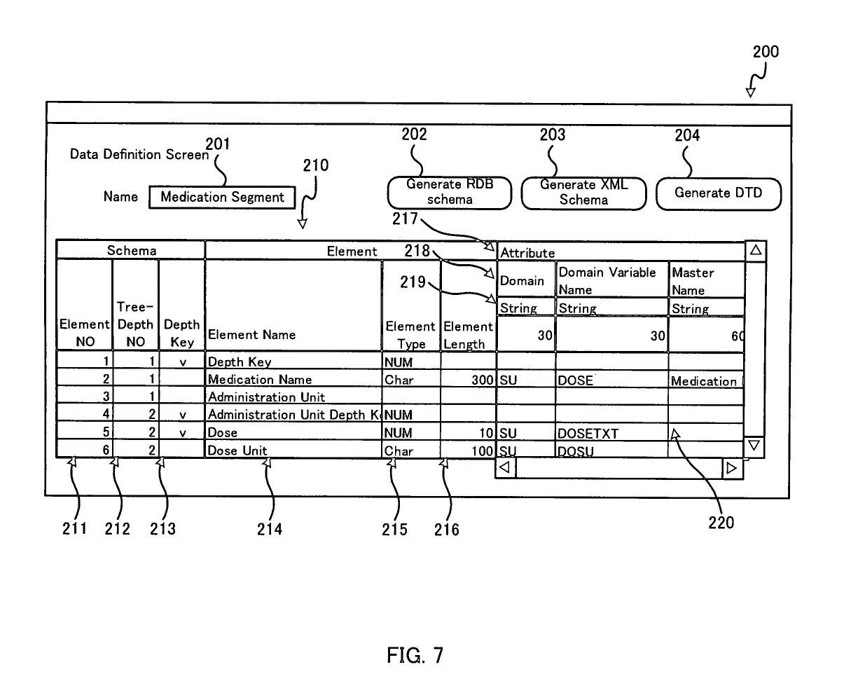

FIG. 7 shows an example of a screen 200 as user interface where users input data definition. The screen 200 comprises a name filed 201, a “Generate RDB schema” button 202, a “Generate XML-data schema in XML Schema” button 203, a “Generate XML-data schema in DTD” button 204, and an element list box 210.

In an element NO column 211 in the element list box 210, element NOs are entered. Elements are vertically listed in the element list box 210 in the order of element NO (an element information output unit). Users are supposed to enter element definitions so that the elements are listed in the depth-first order within the tree structure. Tree-depth NOs are entered in a tree-depth column 212, and a depth key box 213 is checked when the element is designated to be a principal key of the segment. Element names are entered in an element name column 214 and data types and lengths of elements are entered respectively in an element type column 215 and an element length column 216.

In addition, attributes are horizontally listed in the element list box 210. Attribute names, types and lengths are entered respectively in an attribute name row 217, an attribute type row 218, and an attribute length row 219. Default values of attributes are entered for each element in default value fields 220, in the field where the corresponding attribute column meets the element row. For example, FIG. 7 shows that for element “Medication Name”, default values “SU”, “DOSE”, and “Medication Master” are entered with respect to attributes “Domain”, “Domain Variable Name”, and “Master Name” respectively. With such input, the “Medication Name”, element is set so that it can have the attributes of “Domain”, “Domain Variable Name”, and “Master Name”.

On receiving a click on the bottom 202 in the screen 200, the RDB schema generation unit 12 generates RDB schema definition. With a click on the bottom 203 or the bottom 204 in the screen 200, the XML-data schema generation unit 13 generates XML-data schema definition. Incidentally, a process of creating RDB schema definition by the RDB schema generation unit 12 or creating XML-data schema definition by the XML-data schema generation unit 12 is described in detail later on.

In the screen 200, all elements included in tree-structured data are vertically listed in the depth-first order, and all attributes belonging to any of the elements are horizontally listed, and default values of attributes for each element are listed in the field where the corresponding attribute column meets the corresponding element row. With such list, a whole structure of tree-structured data is visibly understandable for users, and at the same time, since possible attributes that may be included in the tree-structured data are all listed up in the screen, users are prevented from missing to set any of necessary default values of attributes.

==Data Registration==

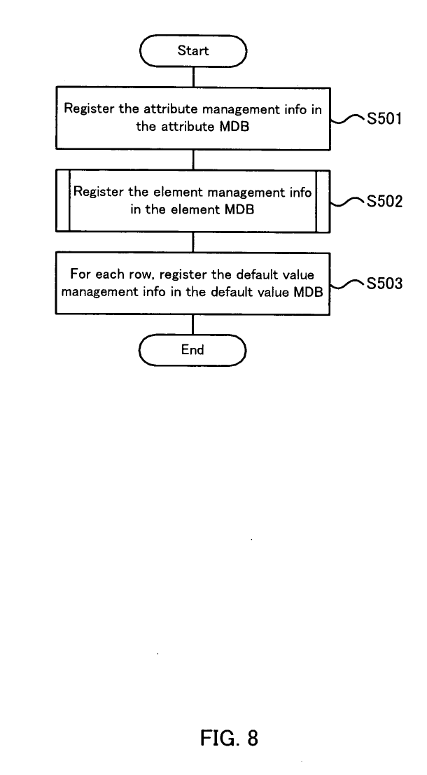

FIG. 8 is a flow chart showing a process of registering information on the databases by the data input unit 11. First, the data input unit 11 generates the attribute management information for each of attributes which have been entered in the attribute name row 217, associating entries in the attribute type row 218 and the attribute length row 219 with the attribute name, and registers the generated attribute management information in the attribute management database 32 (S501). Secondly, the data input unit 11 creates the element management information for each of elements provided in the element list box 210 to register it in the element management database 31 (S502). Thirdly, the data input unit 11 creates the default value management information including element No, attribute ID and default value to register it in the default value management database 33 (S503).

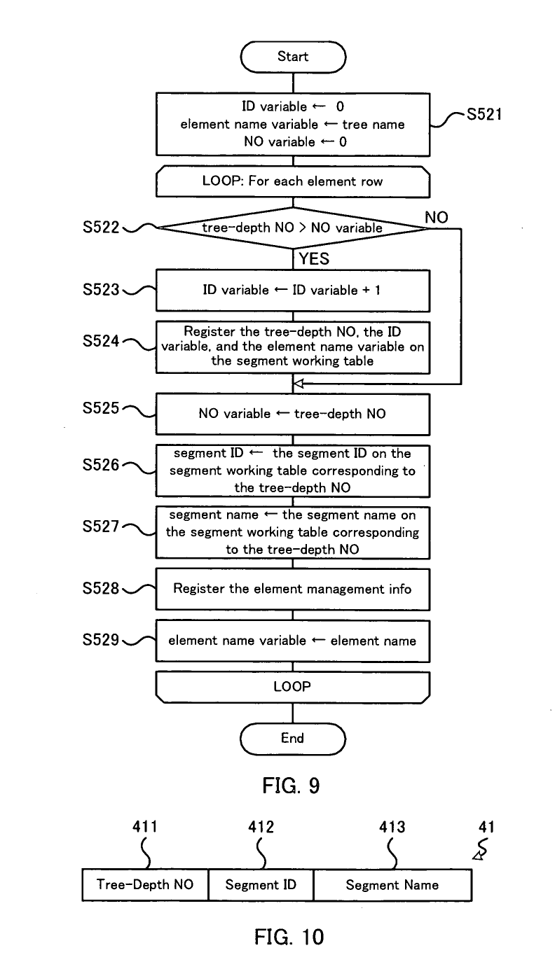

FIG. 9 is a flow chart showing a process of registering element management information. FIG. 10 shows a configuration of a table containing data for use in this process (hereinafter referred to as segment working table 41). As shown in FIG. 10, the segment working table 41 comprises a tree-depth NO 411, a segment ID 412, and a segment name 413.

At start-up, the data input unit 11 initialize variables, assigning “0” to an ID variable, the name of the tree-structured data entered in the screen 200 to an element name variable, and “0” to a NO variable (S521). Then, the data input unit 11 carries out the following process for each row in the element list box 210.

If the tree-depth NO is larger than the NO variable (S522: YES), the data input unit 11 increments the ID variable (S523) and registers the tree-depth NO, the ID variable and the element name variable on the segment working table 41 (S524).

The data input unit 11 assigns the tree-depth NO to the NO variable (S525), and reads out the segment ID 412 and the segment name 413 corresponding to the tree-depth NO on the segment working table 41 (S526 and S527). The data input unit 11 creates element management information, taking the read out segment ID 412 and segment name 413, the element NO entered in the element NO row 211 of the screen 200, the tree-depth NO in the tree-depth NO row 212, the depth key in the check box 213, the element name in the element name row 214, the data type in the element type row 215, and the data length in the element length row 216. The data input unit 11 registers the created information in the element management database 31 (S528). Lastly, the data input unit 11 assigns the element name to the element name variable (S529). By carrying out this process for every row in the element list box 210, the entries in the screen 200 are registered in the element management database 31.

==RDB Schema Generation Unit 12==

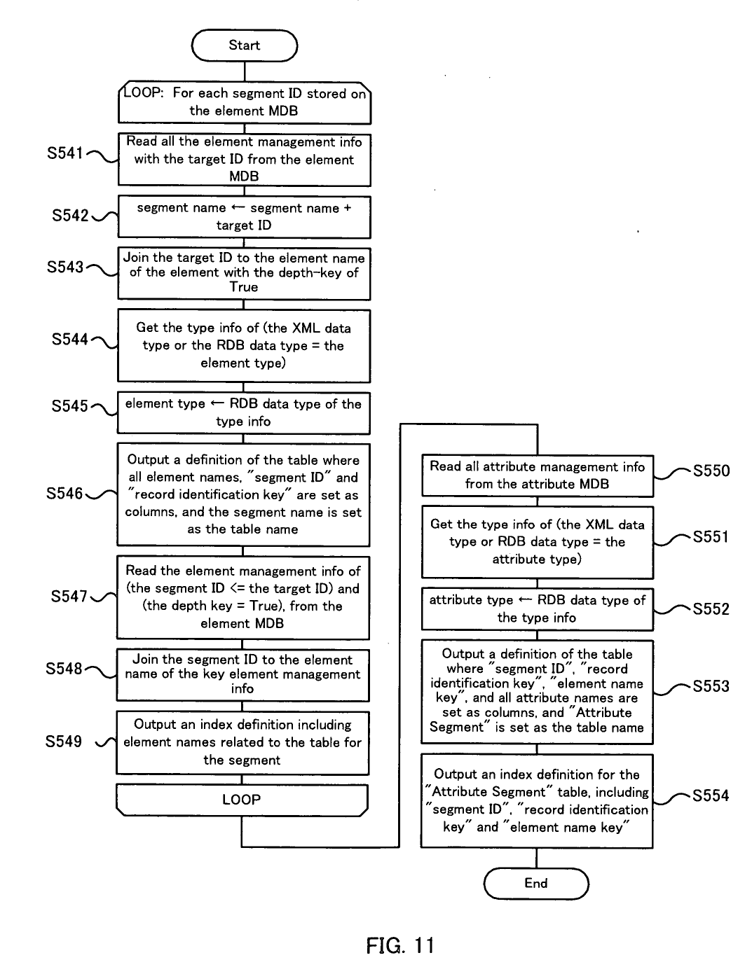

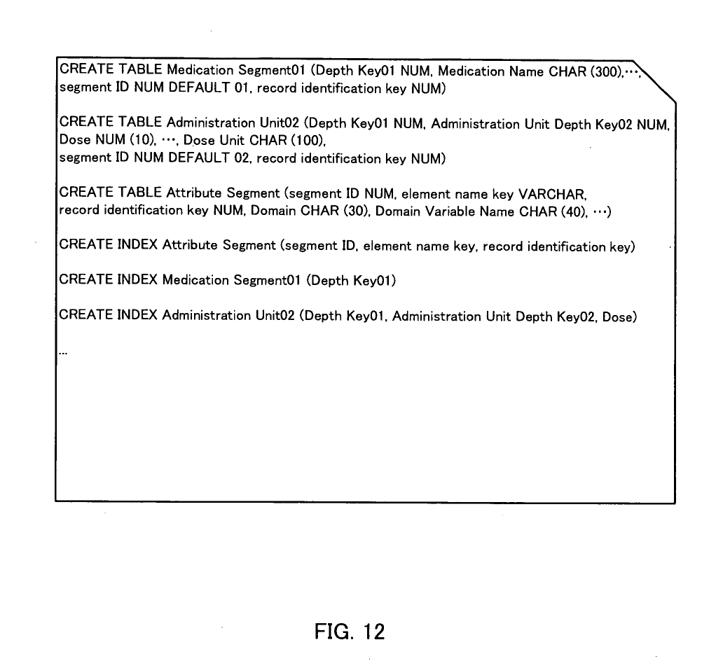

FIG. 11 is a flow chart showing a process of creating a RDB schema definition by the RDB scheme generation unit 12. FIG. 12 shows an example of a RDB schema definition generated by the RDB schema generation unit 12.

The RDB schema generation unit 12 obtains a list of segment IDs 312 stored in the element management database 31, and carries out the following process for each of the obtained segment IDs 312.

The RDB schema generation unit 12 reads out all of the element management information (hereinafter referred to as element-in-segment management information) having the segment ID 312 to be processed (hereinafter referred to as target ID), from the element management database 31 (S541). The RDB schema generation unit 12 joins the target ID to the segment name 313 of the read out element-in-segment management information (S542). For example, in the case that the segment ID 312 is “01” and the segment name 313 is “Medication Segment”, the segment name 313 becomes “Medication Segment 01”.

Among the read out element-in-segment management information, the RDB schema generation unit 12 finds out the information with the depth key 315 set as “True”, and joins the target ID to its element name 311 (S543). For example, in the case that the segment ID 312 is “01” and the element name 316 is “Medication Name”, the element name 316 becomes “Medication Name 01”. For each element-in-segment management information, the RDB schema generation unit 12 looks through the type information database 34 to find out the type information having the same type in either XML data type 341 or RDB data type 342 as the element type 317, and then reads out the RDB data type from the found type information (S544). The unit 12 sets the read out type in the element type 317 of the element-in-segment management information (S545).

The RDB schema generation unit 12 generates a schema definition to define a table where the element name 316 of each element-in-segment management information, “segment ID” and “record identification key” are set as columns, and the name of the target segment is set as the table name (S546). For example, in the case of the information shown in FIG. 3, there are elements “Depth Key”, “Medication Name” and “Administration Unit” that correspond to the segment ID of “01”, and the depth key 315 of the “Depth Key” element is set to “True”. The table created for the target ID of “01” is defined to have the name of “Medication Segment Ol”, and have five columns of “Depth key 01”, “Medication Name”, “Administration Unit”, “segment ID”, and “record identification key”.

In addition, the RDB schema generation unit 12 looks through the element management database 31 to read out all of element management information which meet two conditions, that are, segment ID is under the target ID, and depth key is set to “True” (hereinafter referred to as key element management information) (S547). Then, the unit 12 joins the target ID to the element names 316 of the read out key element management information (S548). After that, the RDB schema generation unit 12 generates a schema definition to define index information indicating all element names related to the table of the target ID, that is, element names of the key element management information (S549). For example, in the case of FIG. 3, the index of “Medication Segment 01” is defined so as to include “Depth Key 01”. By carrying out this process for every segment ID 312, table and index definitions of segments are output.

Next, the RDB schema generation unit 12 reads out all of the attribute management information from the attribute management database 32 (S550). For each of the read out attribute management information, the unit 12 looks through the type information database 34 to find out the type information having the same type in either XML data type 341 or RDB data type 342 as the attribute type 323, and then reads out the RDB data type 342 from the found type information (S551), then sets it in the attribute type 323 of the attribute management information (S552). The RDB schema generation unit 12 outputs a schema definition of a table where “segment ID”, “record identification key”, “element name key”, and attribute names 322 of all attribute management information are set as columns, and “Attribute Segment” is set as the table name (S553). Also, the unit 12 outputs an index definition for the “Attribute Segment” table, which includes “segment ID”, “record identification key”, and “element name key” (S554).

In this way, the RDB schema as shown in FIG. 12 is output. Because the information processor 10 in the present embodiment is adopted to accept depth key as one of inputs related to data definition, it becomes possible to create an index for a table which is created for every segment, so that relations among tables in a relational database can be maintained. Therefore, data having a tree structure as a whole can be well managed, keeping the definitions of distinct tables in it, and it is realized to effectively manage tree-structured data in a relational database.

==XML Schema Generation Unit 13==

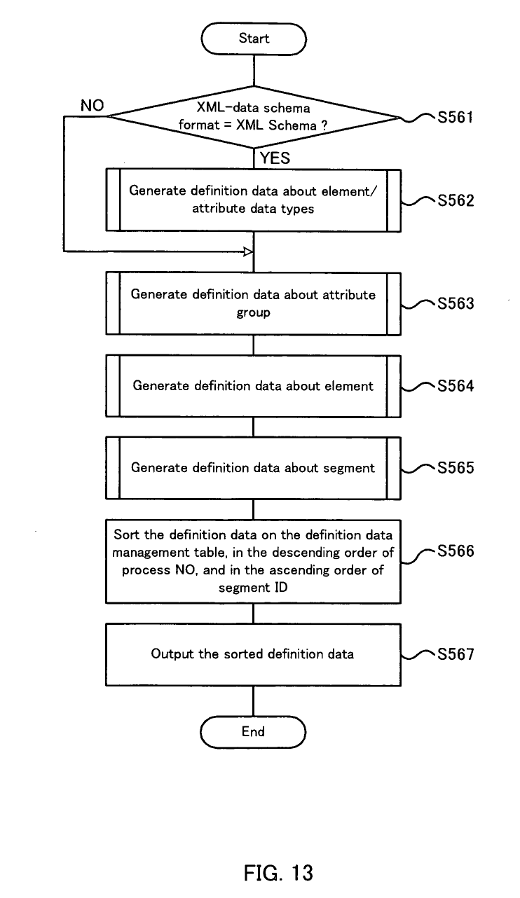

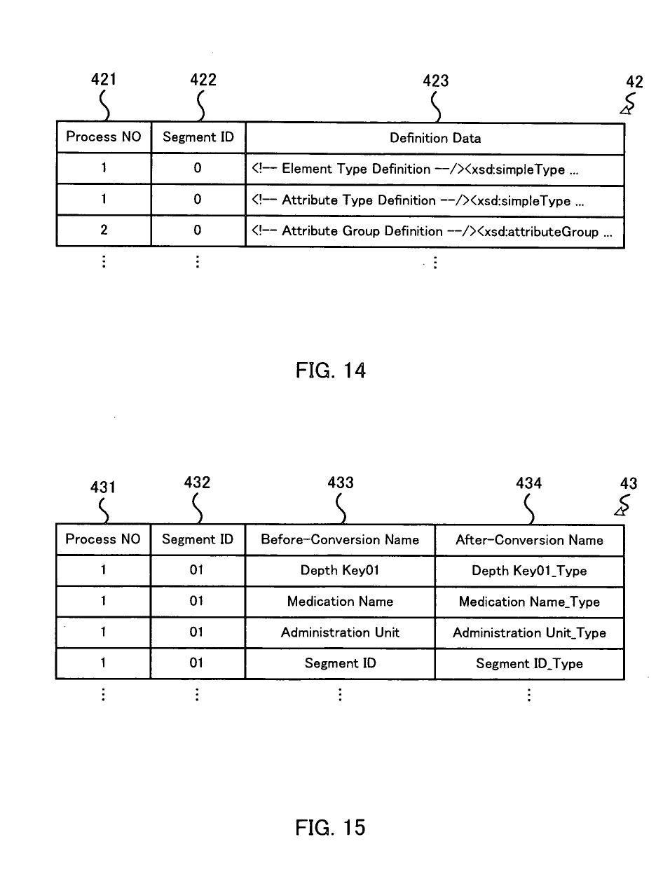

FIG. 13 is a flow chart showing a process of creating a XML-data schema by the XML-data schema generation unit 13. FIGS. 14 and 15 show configurations of two working tables for use in this process. As shown in FIG. 14, a definition data management table 42 comprises a process NO 421, a segment ID 422, and a definition data 423, while an element name conversion table 43, as shown in FIG. 15, comprises a process NO 431, a segment ID 432, a before-conversion name 433, and an after-conversion name 434.

First of all, the XML schema generation unit 13 checks if the XML-data schema to be output will follow the XML Schema format, and if finding it will (S561: YES), the unit 13 goes on to register definition data about element/attribute data types on the definition data management table 42 (S562). After that, the XML-data schema unit 13 generates definition statements for attribute groups (S563), definition statements for elements (S564), and definition statements for segments (S565). Then, the unit 13 registers the definition data in which the generated definition statements are described, on the definition data management table 42. Details of these processes are described later on. Finally, the XML schema generation unit 13 sorts the definition data in the descending order of the process NO 421 as well as in the ascending order of the segment ID 422 on the definition data management table (S566). Then, the unit 13 outputs the sorted definition data as a XML-data schema definition (S567).

==Defining Element/Attribute Data Type==

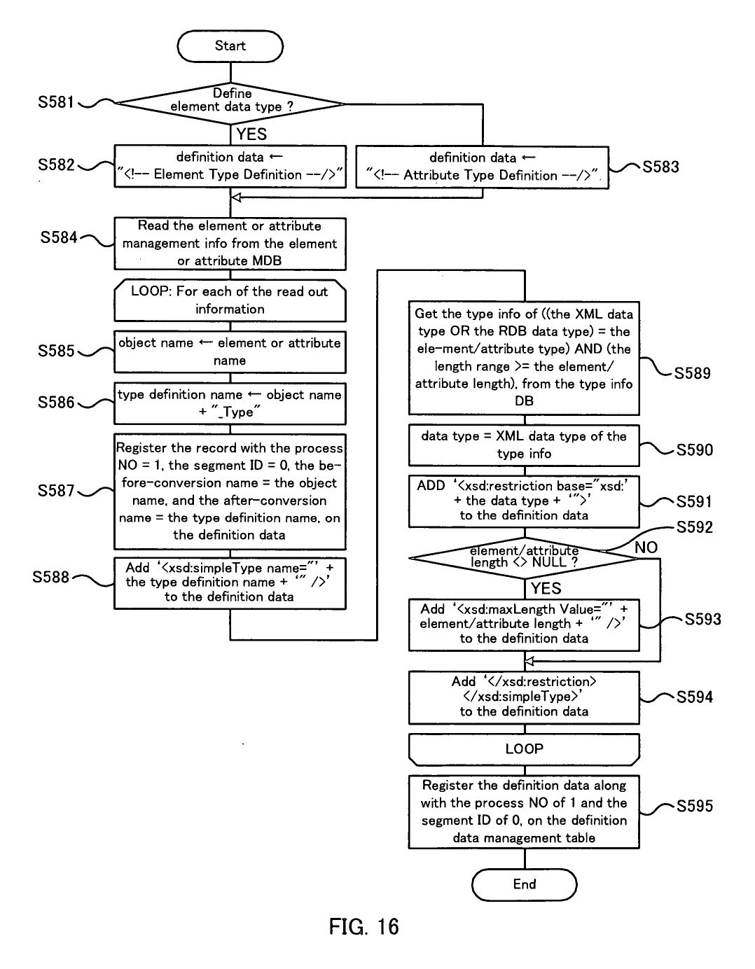

FIG. 16 is a flow chart showing a process of creating a definition of element/attribute data type. The XML-data schema unit 13 carries out this process for each of element and attribute data types.

When defining element data type (S581: YES), the XML-data schema generation unit 13 sets the comment “<!--Element Type Definition-->” in definition data (S582), or when defining attribute data type (S581: NO), the unit 13 sets the comment “<!--Attribute Type Definition-->” in definition data (S583). The XML-data schema generation unit 13 reads out element management information from the element management database 31 when defining element data type, or attribute management information from the attribute management database 32 when defining attribute data type (S584), and then carries out the following process for each of the read out information.

The XML-data generation unit 13 sets the element or attribute name of the read out information to an object name (S585), and creates the name of the definition statement (hereinafter referred to as definition name) by joining “_Type” to the set object name (S586). The XML-data generation unit 13 makes a record by setting “1” in the process NO 431, “0” in the segment ID 432, the object name in the before-conversion name 433, and the definition name in the after-conversion name 434, to register this record on the element name conversion table 43 (S587). The XML-data schema generation unit 13 adds the “<xsd: simpleType>” tag in which the definition name is set in the “name” attribute, to the definition data (S588).

The XML-data schema generation unit 13 looks through the type information database 34 to find out the type information having the same type in either XML data type 341 or RDB data type 342 as the data type of the element or attribute management information, as well as having length range which covers the data length of the element or attribute management information (S589), and picks up the XML data type 341 of the found type information as the data type (S590), and then set this data type in the “base” attribute in the “<xsd: restriction>” tag. The unit 13 adds this tag to the definition data (S591). If the length in the element or attribute management information holds a value (S592: YES), the unit 13 adds the “<xsd: maxLength>” tag in which the length is set in the “Value” attribute, to the definition data (S593). The XML-data schema generation unit 13 adds the “</xsd: restricition>” and “</simpleType>” tags which are the end tags corresponding to the start tags created in the above-mentioned steps S588 and S591, to the definition data (S594). After carrying out this process for each of the records read out from the databases, the XML-data schema generation unit 13 sets “1” and “0” in the process NO 421 and the segment ID 422 respectively, then registers the definition data on the definition data management table 42 (S595).

==Defining Attribute Group==

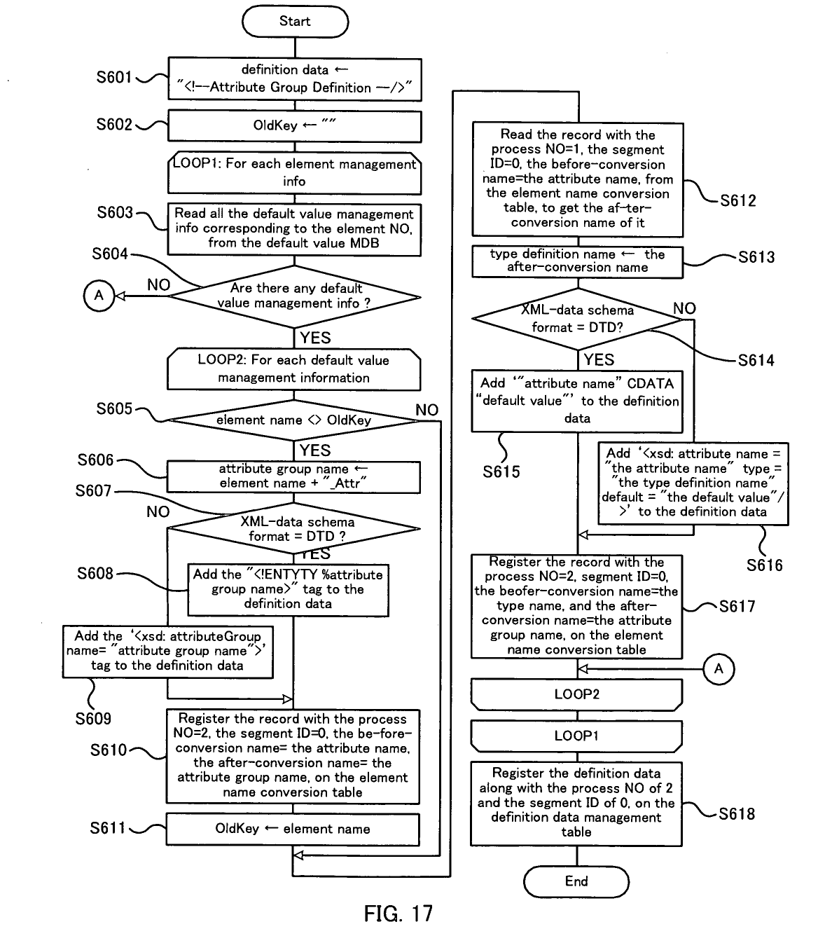

FIG. 17 is a flow chart showing a process of creating an attribute group definition. At the start-up, the XML-data schema generation unit 13 adds the comment “<!--Attribute Group Definition-->” to definition data (S601), and clears an OldKey variable (S602), and then carries out the following process for each of the element management information stored in the element management database 31.

The XML-data schema generation unit 13 reads out the default value management information corresponding to the element NO, from the default value management database (S603). If there is any default value management information (S604: YES), the unit 13 carries out the following process for each default value management information. The unit 13 compares the element name of the element management information with the OldKey (S605). If the element name does not match the OldKey (S605: YES), the unit 13 joins “Attr” to the element name to make the attribute group name (S606). If the XML-data scheme is being defined in accordance with the DTD format (S607: YES), the unit 13 adds the “<!ENTITY>” tag which defines the attribute group name, to the definition data (S608). Meanwhile, if the XML-data scheme is being defined in accordance with the XML Schema format (S607: NO), the unit 13 adds the “<xsd: attributeGroup>” tag in which the attribute group name is set in the “name” attribute, to the definition data (S609). The XML-data schema generation unit 13 makes a record in which “2”, “0”, the attribute name identified from the attribute management information corresponding to the attribute ID, and the attribute group name are respectively set in the process NO 431, the segment ID 432, the before-conversion name 433, and the after-conversion name 434 to register this record on the element name conversion table 43 (S610), and then sets the element name in the OldKey variable (S611).

The XML-data schema generation unit 13 looks through the element name conversion table 43 to find out the record having the process NO 431 of “1” and the segment ID 432 of “0”, and the before-conversion name 433 which matches the attribute name, and obtains after-conversion 434 of that record (S612). The unit 13 sets the obtained after-conversion name 434 as the type definition name (S613). If the XML-data scheme is being defined in accordance with the DTD format (S614: YES), the unit 13 adds a string which is made by joining the attribute name, “CDATA” and the default value of the default value management information with punctuating them with a blank, to the definition data (S615). Meanwhile, if the XML-data scheme is being defined in accordance with the XML Schema format (S614: NO), the unit 13 adds the “<xsd: attribute>” tag in which the attribute name identified before, the type definition name set before, and the default value of the default value management information are set respectively in the “name” attribute, the “type” attribute, and the “default” attribute, to the definition data (S616). The XML-data schema generation unit 13 makes a record in which “2”, “0”, the type name, and the attribute group name are set respectively in the process NO 431, the segment ID 432, the before-conversion name 433, and the after-conversion name 434 to register this record on the element name conversion table 43 (S617). The unit 13 carries out the process described above for each default value management information.

After carrying out this process for each of the element management information, the XML-data schema generation unit 13 registers the definition data on the definition data management table 422, setting “2” and “0” in the process NO 421 and the segment ID 422 respectively (S618).

==Defining Element==

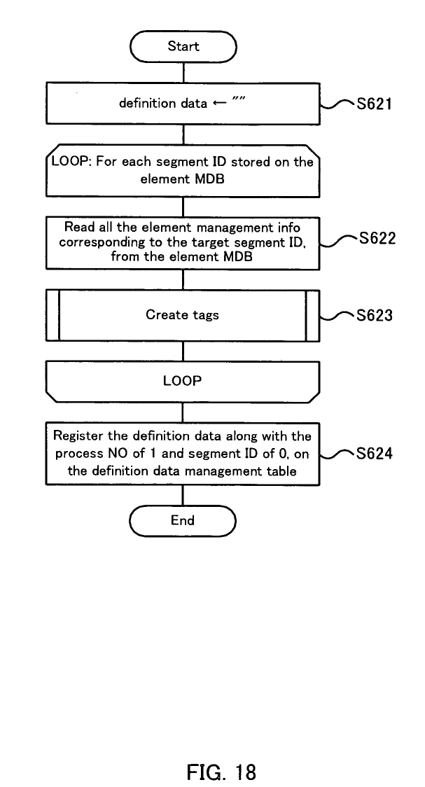

FIG. 18 is a flow chart showing a process of creating an element definition. At the start-up, the XML-data schema generation unit 13 empties definition data to initialize it (S621). Then, the unit 13 obtains the segment IDs without duplication from the element management database 31, and carries out the following process for each of the obtained segment IDs.

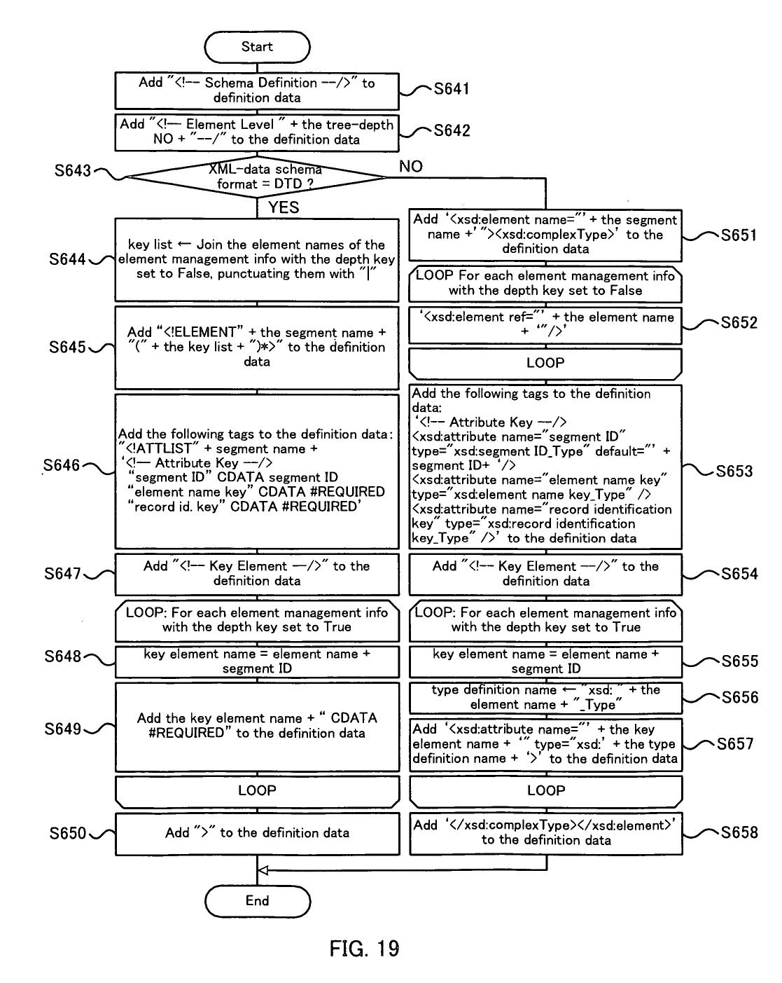

The XML-data generation unit 13 reads out all of the element management information corresponding to the segment ID to be processed (hereinafter referred to as element-in-target-segment management information), from the element management database 31 (S622). Then, the unit 13 carries out a process of creating tags shown in FIG. 19, based on the read out element-in-target-segment management information (S623).

The XML-data schema generation unit 13 adds the comment “<!--Schema Definition-->” (S641), and the string which is made by joining “<!--Element Level”, the tree-depth NO, and “-->” (S642), to the definition data. If the XML-data scheme is being defined in accordance with the DTD format (S643: YES), the XML-data generation unit 13 extracts all of the element management information with the depth key set as “False” from the element-in-target-segment management information. Then, the unit 13 sets the string which is made by joining the element names of the extracted element management information with punctuating them with “|”, as a key list (S644). Then, the unit 13 adds the “<!ELEMENT segment name (key list)>” tag to the definition data (S645). Then, the unit 13 adds the following lines to the definition data (S646): “<!ATTLIST” &the segment name; the comment line “<!--Attribute Key-->”; “segment ID CDATA” & the segment ID; “element name key CDATA #REQUIRED”; and “record identification key CDATA #REQUIRED”. In addition, the unit 13 adds the “<!--Key Element-->” comment to the definition data (S647). The XML-data generation unit 13, at this time, extracts the element management information with the depth key set as “True” from the element-in-target-segment management information. Then, for each of the extracted information, the unit 13 joins the segment ID to the element name (S648), and adds the line in which the element name with the segment ID is further joined to the “CDATA #REQUIRED” string, to the definition data (S649). Lastly, the unit 13 adds “>” to the definition data to close the tag (S650).

Meanwhile, If the XML-data scheme is being defined in accordance with the XML Schema format (S643: NO), the XML-data schema generation unit 13 adds the “<xsd: element>” tag in which the segment name is set in the “name” attribute, and the “<xsd: complexType>” tag to the definition data (S651). The XML-data schema generation unit 13 extracts all of the element management information with the depth key set as “False” from the element-in-target-segment management information, and for each of extracted information, adds the “<xsd: element>” tag in which the element name of the information is set in the “ref” attribute, to the definition data (S652). Then, the XML-data schema generation unit 13 adds the following lines to the definition data: the “<!--Attribute Key-->” comment; the “<xsd: attribute>” tag in which “segment ID”, “xsd: segment ID_Type”, and the segment ID are set respectively in the “name” attribute, the “type” attribute, and the “default” attribute; the “<xsd: attribute>” tag in which “element name key” and “xsd: element name key_Type” are set in the “name” attribute and the “type” attribute respectively; the “<xsd: attribute>” tag in which “record identification key” and “xsd: record identification key_Type” are set in the “name” attribute and the “type” attribute respectively (S653); and the <!--Key Element--/> comment (S654).

The XML-data generation unit 13, at this time, extracts the element management information with the depth key set as “True” from the element-in-target-segment management information. For each of the extracted information, the unit 13 creates the key element name by joining the segment ID to the element name (S655), and also creates the type definition name by joining the “xsd: ” string and the key element name and the “_Type” string (S656). Then, the unit 13 adds the “<xsd: attribute>” tag in which the created key element name is set in the “name” attribute and the created type definition name is set in the “type” attribute, to the definition data (S657). Finally, the unit 13 adds the end tags “</xsd: complexType>” and “</xsd: element>” corresponding to the start tags created in the above-mentioned step S651, to the definition data (S658).

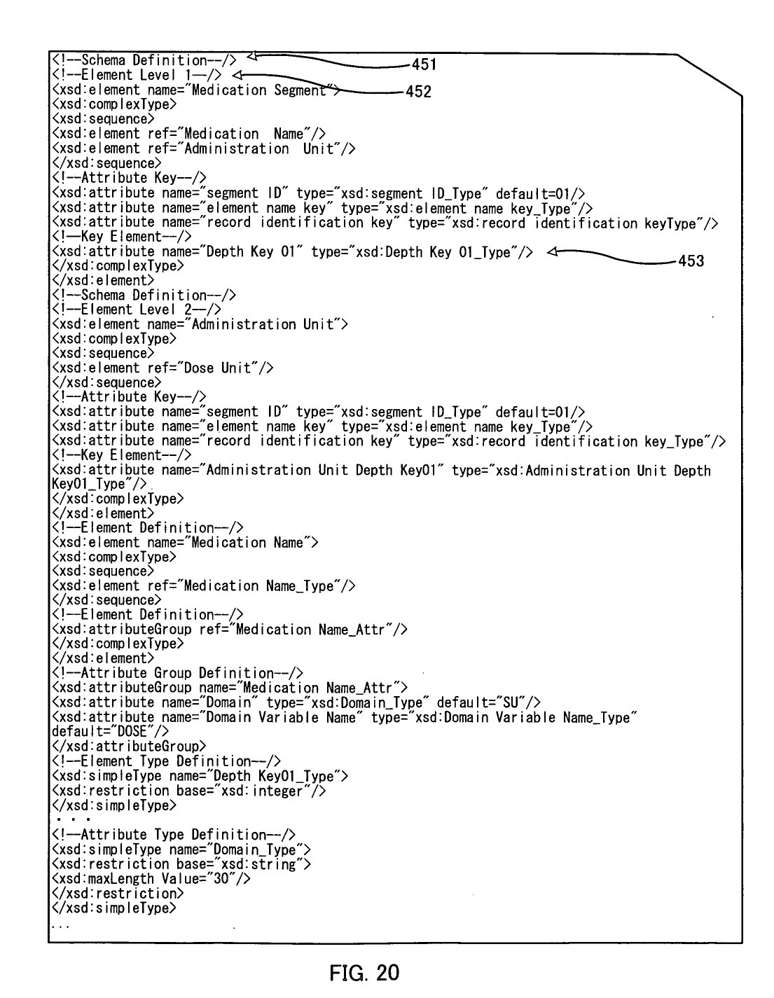

FIG. 20 shows an example of a XML-data schema definition generated in this way. The definition shown in FIG. 20 is an example in accordance with the XML Schema format. As shown in FIG. 20, it is easy to understand what kind of definition statement is where, thanks to the comment lines 451 and 452 and others. Therefore, as described later on, the XML-data schema input unit 14 can easily find out necessary schema information by analyzing the schema definition based on the comments as mentioned-above. In addition, in the information processor 10 of the present embodiment, with respect to the element which is a primary key for a segment in a relational database, the definition statement 453 which indicates key element is created in the XML-data schema so that the element is treated as one of attributes belonging to the segment which is itself an element. That is, a XML-data schema can be generated without losing information about depth key, and in exchanging the XML-data schema definition, the depth key information can be transferred along therewith.

==XML-Data Schema Input Unit 14==

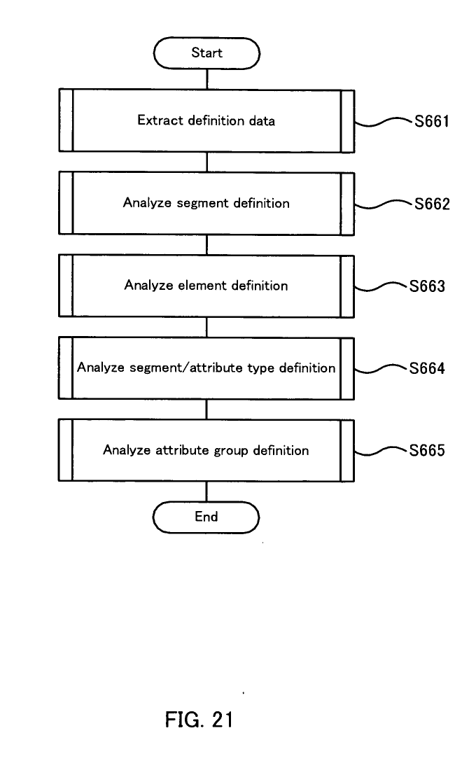

FIG. 21 is a flow chart showing a process of reading a XML-data schema by the XML-data schema input unit 14. As shown in FIG. 21, the XML-data schema input unit 14 extracts definition data from the provided XML-data schema (S661), and analyzes segment definition statements in the extracted data to register element management information (S662). Then, the XML-data schema input unit 14 analyzes element definition statements and extracts definition statements referring the attribute group related to the element (S663), and then analyzes definition statements about element/attribute data type and updates type and length of element/attribute management information (S664). Lastly, the XML-data schema input unit 14 analyzes definition statements about attribute group to register the default value management information (S665). Now, each of these processes is described in detail.

==Extracting Definition Data==

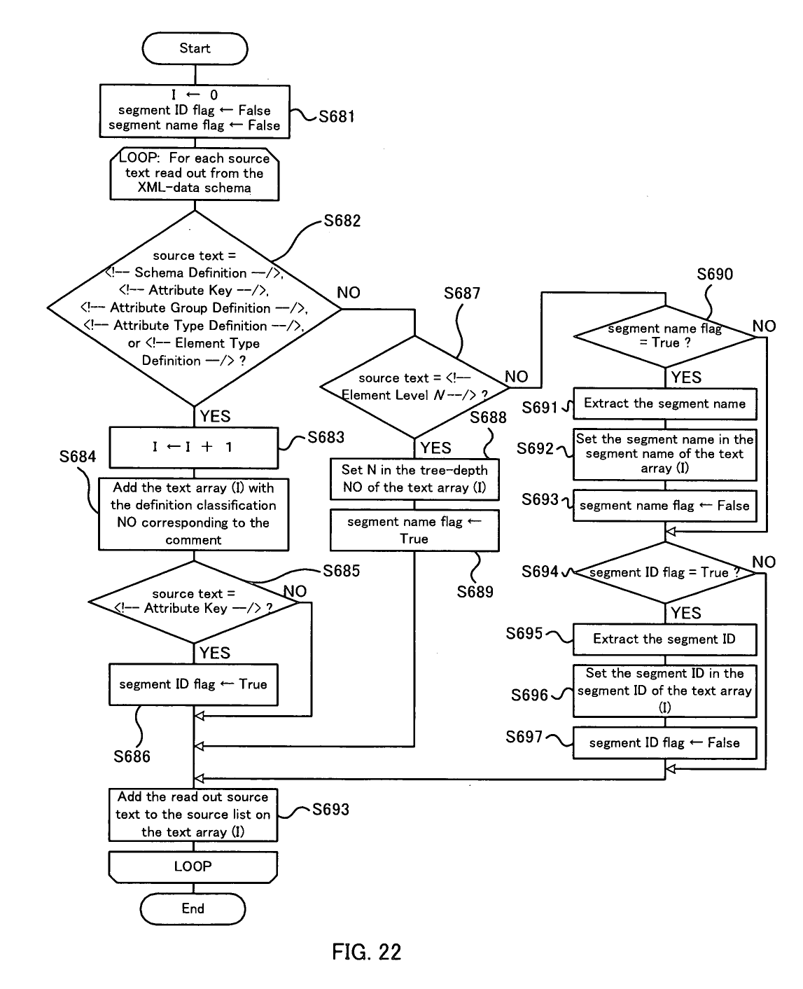

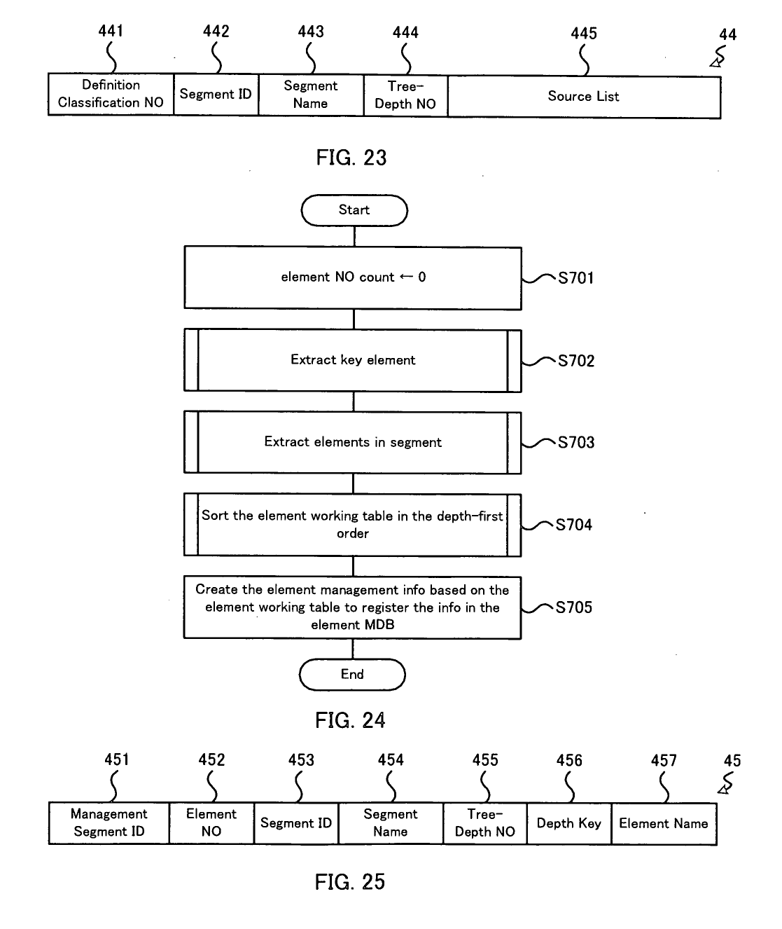

FIG. 22 is a flow chart showing a process of extracting definition data. FIG. 23 shows a configuration of a text array 44 which holds working data for use in this process. As shown in FIG. 23, the text array 44 contains a definition classification NO 441, a segment ID 442, a segment name 443, a tree-depth NO 444, and a source list 445, associating each other. In the present embodiment, each array element in the text array 44 is identified with a number starting from 1. In the following, the I-th array element in the text array 44 is expressed as text array 44 (I). String of line read out from XML-data schema (hereinafter referred to as source text) is stored in the source list 445.

At the start-up, the XML-data schema input unit 14 sets “0”, “False”, and “False” in a variable I, a segment ID flag, and a segment name flag respectively (S681). The XML-data schema input unit 14 reads out source texts one by one from XML-data schema, and then carries out the following process for each of the read source texts.

The XML-data schema input unit 14 determines whether or not the source text matches any one of the comments that are “<!--Schema Definition-->”, “<!--Attribute Key-->”, “<!--Attribute Group Definition-->”, “<!--Attribute Type Definition-->” and “<!--Element Type Definition-->” (S682). If the source text does match any one of these comments (S682: YES), the unit 14 increments the I (S683) and creates a new array element of text array 44 (I) (S684). Here, the XML-data schema input unit 14 sets “1” in the definition classification NO if the source text matches “<!--Schema Definition-->”, sets “2” if the text matches “<!--Element Definition-->”, sets “3” if the text matches “<!--Attribute Group Definition-->”, sets “4” if the text matches “<--Attribute Type Definition-->”, or sets “5” if the text matches “<!--Element Type Definition--/>. Furthermore, if the source text matches “<!--Attribute Key-->” (S685: YES), the XML-data schema input unit 14 sets “True” to the segment ID flag (S686).

Meanwhile, if the source text does not matches any of those comments (S682: NO), the XML-data schema input unit 14 determines whether or not the source text matches “<!--Element Level N-->” (where N is a number) (S687). If the source text does (S687: YES), the unit 14 sets the number N in the tree-depth NO 444 of the text array 44 (I) (S688), and then sets “True” to the segment name flag (S689).

If the source text does not matches the statement “<!--Element Level N—/>” (S687: NO), the XML-data schema input unit 14 determines whether or not the segment name flag is set to “True”. If the flag is so (S690: YES), the XML-data schema input unit 14 extracts the segment name from the source text (S691), and sets the extracted segment name in the segment name 443 of the text array 44 (I) (S692), and sets the segment name flag to “False” (S693). Incidentally, the XML-data schema input unit 14 extracts the segment name from the “name” attribute in the “<xsd: element>” tag if the XML-data schema follows the XML Schema format, or takes the name following “ELEMENT” in the “<!ELEMENT>” tag as the segment name if the XML-data schema follows the DTD format.

If the segment ID flag is set to “True” (S694: YES), the XML-data schema input unit 14 extracts the segment ID from the source text (S695), and sets the extracted segment ID in the segment ID 442 of the text array 44 (I) (S696), and sets the segment ID flag to “False” (S697). Incidentally, the XML-data schema input unit 14 extracts the segment ID from the “default” attribute in the “<xsd: attribute>” tag with the “name” attribute of “segment ID” if the XML-data schema follows the XML Schema format, or takes the value following “segment ID CDATA” as the segment ID if the XML-data schema follows the DTD format.

Finally, the XML-data schema input unit 14 adds the source text to the source list 445 in the text array 44 (I) (S693).

In this way, XML-data schema is divided into several parts, that are, segment definition part, element definition part, definition part about attribute group per element, definition parts about element/attribute data type, based on the comment inserted therein, and then stored in the text array 44.

Analyzing Segment Definition==

FIG. 24 is a flow chart showing a process of analyzing a segment definition. FIG. 25 shows a configuration of an element working table 45 for use in this process. As shown in FIG. 25, the element working table 45 comprises a management segment ID 451, an element NO 452, a segment ID 453, a segment name 454, a tree-depth NO 455, a depth key 456, and an element name 457. In addition, the element name conversion table 43 shown in FIG. 15 described before is also used in this process.

The XML-data schema input unit 14 assigns “0” to an element line count variable (S701), extracts the definition about an element which is a primary key of the segment (hereinafter referred to as key element) (S702), and extracts the definition about elements included in the segment (S703). After records are registered in the element working table 45 by these processes, the XML-data schema input unit 14 sorts the records according to the depth-first order within the tree structure (S704), and creates element management information, based on the items on the element working table 45 except for the management segment ID 451. Then, the unit 14 registers the created element management information in the element management database 31 (S705).

In the following, each of these processes is described in detail.

==Extracting Key Element==

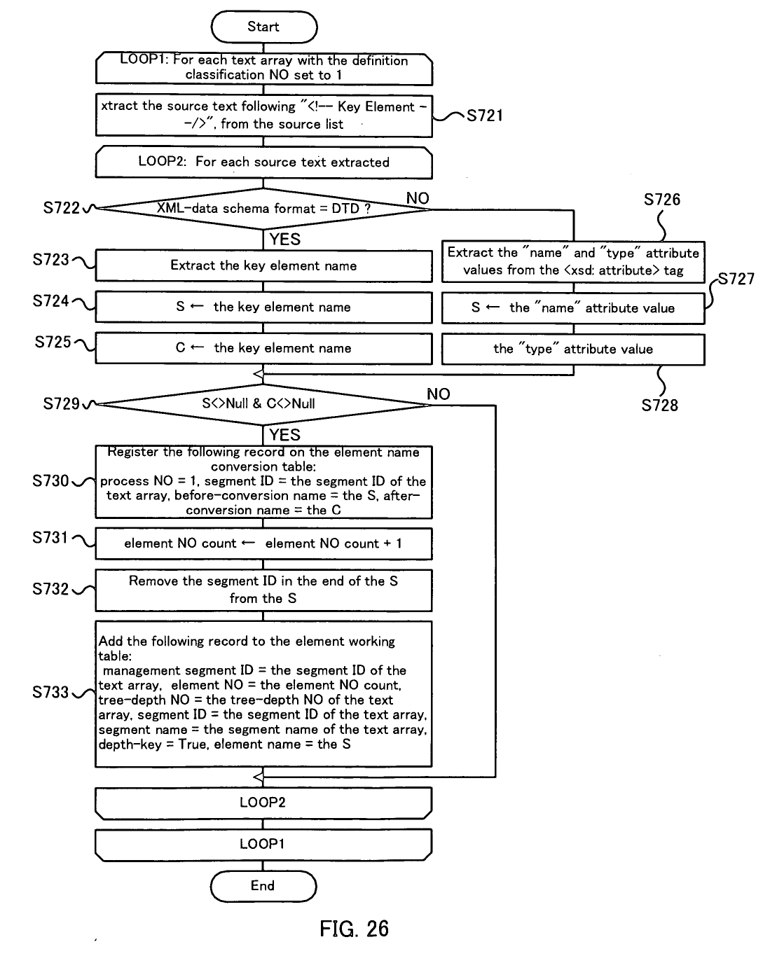

FIG. 26 is a flow chart showing a process of analyzing a key element definition. The XML-data schema input unit 14 carries out the following process for each of array elements with the definition classification NO of “1” in the text array 44.

The XML-data schema input unit 14 extracts the source texts following <!--Key Element-->” from the source list (S721), and carries out the following process for each of the extracted source texts.

If the XML-data schema follows the DTD format (S722: YES), the XML-data schema input unit 14 extracts the name of the key element from “attribute name CDATA #REQUIRED” in the “<!ATTLIST>” tag (S723), and sets the extracted name to S and C (S724 and S725). Meanwhile, if the XML-data schema follows the XML Schema format (S722: NO), the XML-data schema input unit 14 extracts the “name” and “type” attribute values in the “<xsd: attribute>” tag (S726), and sets the “name” attribute value to S (S727) and the “type” attribute value to C (S728).

With being able to extract the name and type (S 729: YES), the XML-data schema input unit 14 registers “1” in the process NO 431, the segment ID 442 of the array element in the segment ID 432, the S in the before-conversion name 433, and the C in the after-conversion name 434, on the element name conversion table 43 (S730). Then, the unit 14 increments the element NO count (S731), and removes segment ID put in the end of the S from the S (S732). The unit 14 makes a record where the segment ID 442 of the array element is set in the management segment ID 451, the element NO count is set in the element NO 452, the tree-depth NO 444 of the array element is set in the tree-depth NO 455, the segment ID 442 of the array element is set in the segment ID 453, the segment name 443 of the array element is set in the segment name 454, “True” is set to the depth key 456, and the S is set in the element name 457, and registers this record on the element working table 45 (S733).

==Analyzing Element-in-Segment Definition==

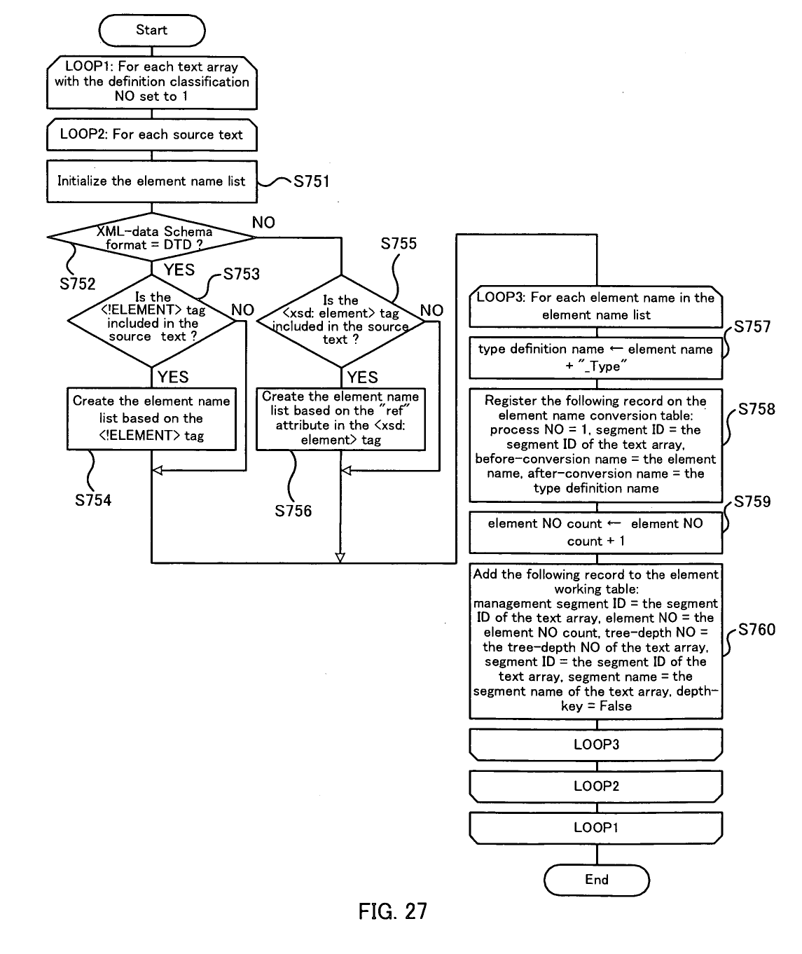

FIG. 27 is a flow chart showing a process of analyzing a definition about elements constituting tree-structured data. The XML-data schema input unit 14 carries out the following process for each of array elements with the definition classification NO of “1” in the text array 44, with respect to each source text included in the source list 445.

At the start-up, the XML-data schema input unit 14 initializes an element name list (S751). If the XML-data schema follows the DTD format, the XML-data schema input unit 14 finds out whether or not the source text includes the “<!ELEMENT> tag. If it does (S753: YES), the XML-data schema input unit 14 extracts element names form the “<!ELEMENT> tag (S754). The element names can be extracted by dividing the string inside the parenthesis at the mark “|”. If the XML-data schema follows the XML Schema format (S75: NO), the XML-data schema input unit 14 finds out whether or not the source text includes the “<xsd: element> tag. If it does (S755: YES), the XML-data schema input unit 14 extracts element names from the “ref” attributes in the “<xsd: element>” tags to make the element name list (S756).

For each of element names included in the list created in this way, the XML-data schema input unit 14 makes the type definition name by joining the element name with “_Type” (S757). Then, the unit 14 makes a record where “1” is set in the process NO 431, the segment ID 442 of the array element is set in the segment ID 432, the element name is set in the before-conversion name 433, and the type definition name is set in the after-conversion name 434, and registers this record on the element name conversion table 43 (S758). Then, the XML-data schema input unit 14 increments the element NO count (S759), and makes a record where the segment ID 442 of the array element is set in the management segment ID 451, the element NO count is set in the element NO 452, the tree-depth NO 444 of the array element is set in the tree-depth NO 455, the segment ID 442 of the array element is set in the segment ID 453, the segment name 443 of the array element is set in the segment name 454, and “False” is set to the depth key 456, to register this record on the element working table 45 (S760).

==Sorting Element Working Table 45==

Next, the XML-data schema input unit 14 sorts the element working table 45 created in the above-mentioned way, so as for its records to be listed in the depth-first order within the tree structure. The present embodiment adopts a method comprising first determining two segments which correspond to leaves of tree (elements at the deepest depth), and then sorting the table so as for the records included in the determined two segments to get listed up in series. In the following, a process of sorting the element working table 45 is described in detail with a specific example taken. The example below is also using the above-mentioned text array 44 which contains source texts of XML-data schema.

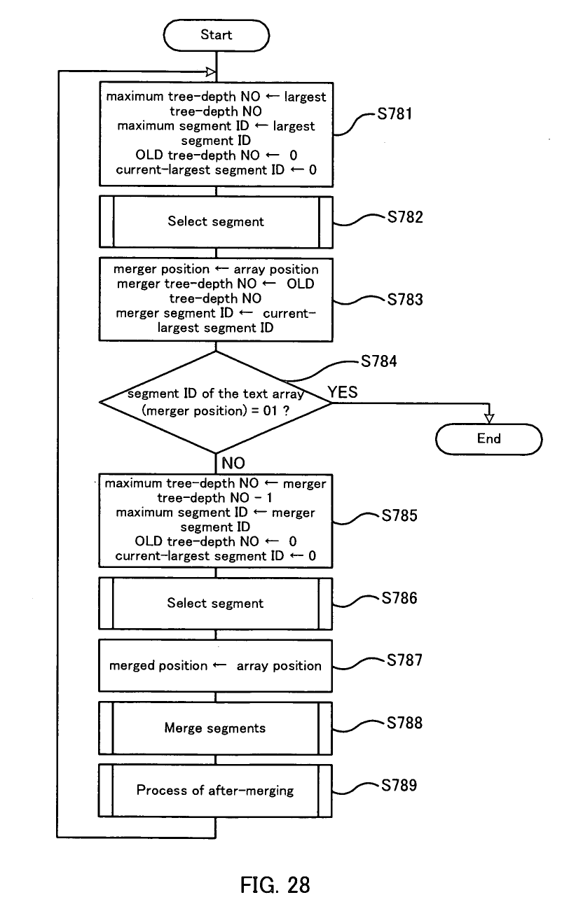

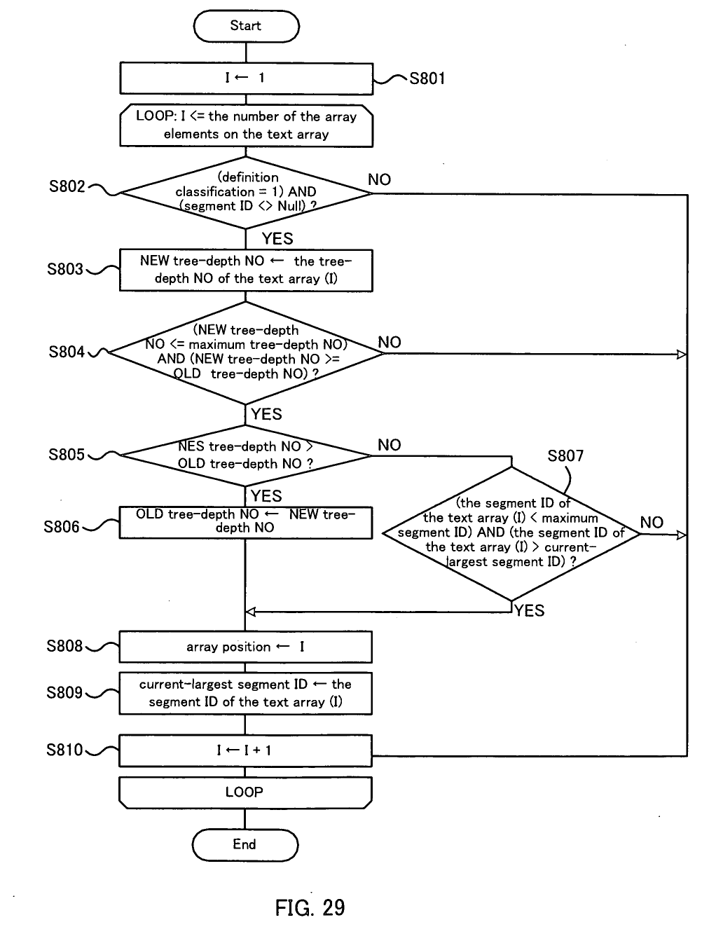

FIG. 28 is a flow chart showing a process of sorting the element working table 45 so as for the records to be listed in the depth-first order. At the start-up, the XML-data schema input unit 14 looks for the largest value out of the tree-depth NOs 455 contained in the element working table 45 to set the value in a maximum tree-depth NO, and also looks for the largest value out of the segment IDs 453 to set the value in a maximum segment ID, and further, the unit 14 sets “0” in both of an OLD tree-depth NO and a current-largest segment ID, for the purpose of initializing the variables (S781). Then, the XML-data schema input unit 14 goes to a process of selecting the segment shown in FIG. 29 (S782).

In the process of selecting the segment shown in FIG. 29, the XML-data schema input unit 14 first sets “1” in the I (S801) and carries out the following process until the variable I exceeds the number of array elements on the text array.

The XML-data schema input unit 14 determines whether or not the text array 44 (I) meets the following two conditions: its definition classification NO is “1”, and its segment ID holds any value. If the array element meets them (S802: YES), the XML-data schema input unit 14 sets the tree-depth NO of the text array 44 (I) in a NEW tree-depth NO (S803). Then the XML-data schema input unit 14 determines whether or not the NEW tree-depth NO meets the following two conditions: it is equal to or smaller than the maximum tree-depth NO, and it is equal to or larger than the OLD tree-depth NO. If the NEW tree-depth NO meets them (S804: YES), and also is determined larger than the OLD tree-depth NO (S805: YES), the XML-data schema input unit 14 sets the NEW tree-depth NO in the OLD tree-depth NO (S806).

Meanwhile, if the NEW tree-depth NO is not larger than the OLD tree-depth NO (S805: NO), the unit 14 determines if the segment ID of the text array (I) meets the following two conditions: it is smaller than the maximum segment ID, and it is larger than the current-largest segment ID. If the array element does not meet them (S807: NO), the XML-data schema input unit 14 goes to the step S810 and restart the steps from S802 with respect to the next array element of the text array 44.

If the result of the step S805 is YES, or the result of the step S807 is YES, the XML-data schema input unit 14 sets the I to the array position (S808) and sets the segment ID of the text array 44 (I) to the current-largest segment ID (S809), and then increments the I (S010).

After finishing the above-mentioned selecting process, the XML-data schema input unit 14 sets the present array position in a merger position, and sets the present OLD tree-depth NO in a merger tree-depth NO, and sets the preset current-largest segment ID in a merger segment ID (S783). In the case that the segment ID of the text array (merger position) is “01” (S784: YES), then the sorting process comes to an end.

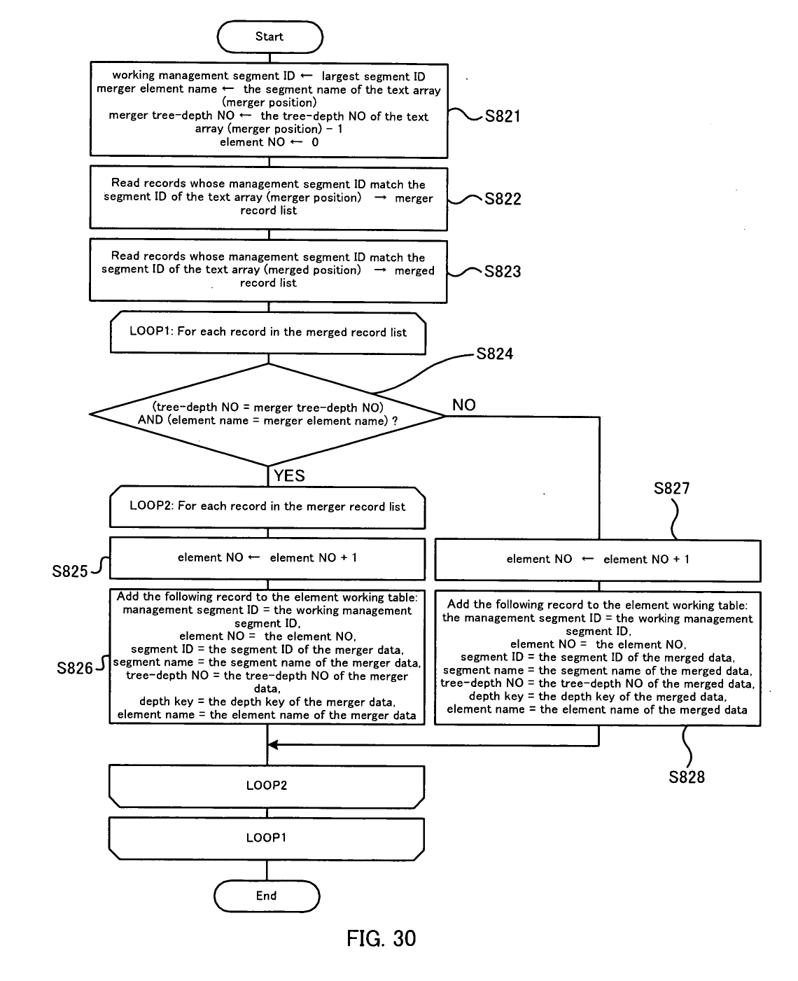

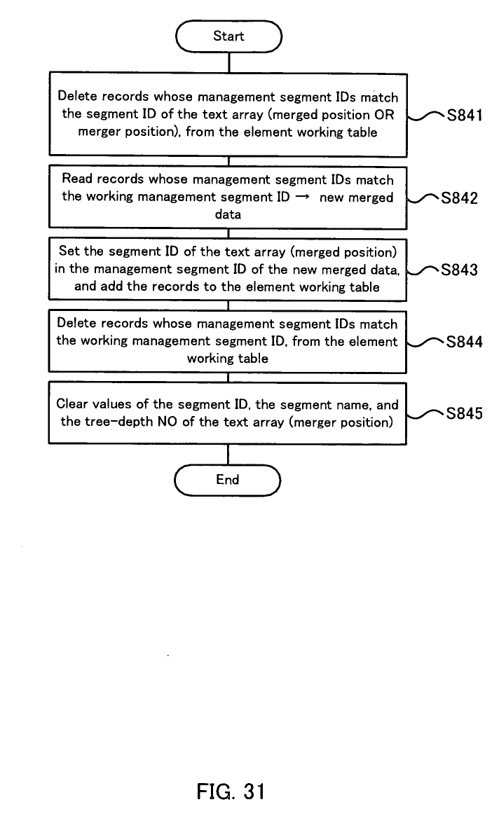

Otherwise (S784: NO), the XML-data schema input unit 14 sets variables, taking the value resulting from subtracting “1” from the merger tree-depth NO as the maximum tree-depth NO, the merger segment ID as the maximum segment ID, and “0” as both of the OLD tree-depth NO and the current-largest segment ID (S785). Then, the XML-data schema input unit 14 again carries out the process shown in FIG. 29 (S786), and takes the resulted array position as a merged position (S787). Following that, the XML-data schema input unit 14 carries out a process of merging the segments shown in FIG. 30 (S788) and a process of after-merging shown in FIG. 31 (S789), then goes back to the step S781 to restart the processes.

In the process of merging the segments shown in FIG. 30, the XML-data schema input unit 14 first sets the largest value of the segment ID 453 contained in the element working table 45 to a working management segment ID, and sets the segment name 443 of the text array 44 (merger position) to a merger element name, and sets the value resulting from subtracting “1” from the tree-depth NO 444 of the text array 44 (merger position) to a merger tree-depth NO, and sets “0” in an element NO, to initialize variables (S821). The XML-data schema input unit 14 looks through the element working table 45 to read out records whose management segment IDs 451 match the segment ID 442 of the text array 44 (merger position), and makes a merger record list from the read out records (S822). Then, the XML-data schema input unit 14 again looks through the element working table 45 to read out records whose management segment IDs 451 match the segment ID 442 of the text array 44 (merged position), and makes a merged record list from the read out records (S823). Next, the XML-data schema input unit 14 carries out the following process for each record in the merged record list (hereinafter referred to as merged data).

If the tree-depth NO 455 of the merged data matches the merger tree-depth NO, and also the element name 457 of the merged data matches the merger element name (S824: YES), the XML-data schema input unit 14 carries out the registering process for each record in the merger record list (hereinafter referred to as merger data) as follows: increment the element NO (S825); make a record where the working management segment ID is set in the management segment ID 451, the element NO is set in the element NO 452, the segment ID 453 of the merger data is set in the segment ID 453, the segment name 454 of the merger data is set in the segment name 454, the tree-depth NO 455 of the merger data is set in the tree-depth NO 455, the depth key 456 of the merger data is set in the depth key 456, and the element name 457 of the merger data is set in the element name 457; register this record on the element working table 45 additionally (S826).

Meanwhile, If the tree-depth NO 455 of the merged data does not match the merger tree-depth NO, or if the element name 457 of the merged data does not match the merger element name (S824: NO), the XML-data schema input unit 14 increments the element NO (S827), and makes a record where the working management segment ID is set in the management segment ID 451, the element NO is set in the element NO 452, the segment ID 453 of the merged data is set in the segment ID 453, the segment name 454 of the merged data is set in the segment name 454, the tree-depth NO 455 of the merged data is set in the tree-depth NO 455, the depth key 456 of the merged data is taken as the depth key 456, and the element name 457 of the merged data is set in the element name 457, to register this record on the element working table 45 additionally (S828).

In the process of after-merging shown in FIG. 31, the XML-data schema input unit 14 first deletes records whose management segment IDs 451 match the segment ID 442 of the text array 44 (either merged position or merger position), from the element working table 45 (S841). Then, the XML-data schema input unit 14 reads out records whose management segment IDs 451 match the working management segment ID (S842), and sets the segment ID 442 of the text array 44 (merged position) in the management segment ID 451 of the read out records, and then additionally register the newly set records on the element working table 45 (S843). The XML-data schema input unit 14 then deletes records whose management segment IDs 451 match the working management segment ID from the element working table 45 (S844), and clears values of the segment ID 442, the segment name 443 and the tree-depth NO 444 of the text array 44 (merger position) (S845).

In this way, the XML-data schema input unit 14 carries out sorting by first finding out the segment whose tree-depth NO and segment ID are the largest and determining two segments which correspond to leaves of tree in the tree structure, and then arranging records so as for the determined two segments to be listed in series. As a result, records on the element working table 45 can be sorted in the depth-first order.

==Analyzing Element Definition==

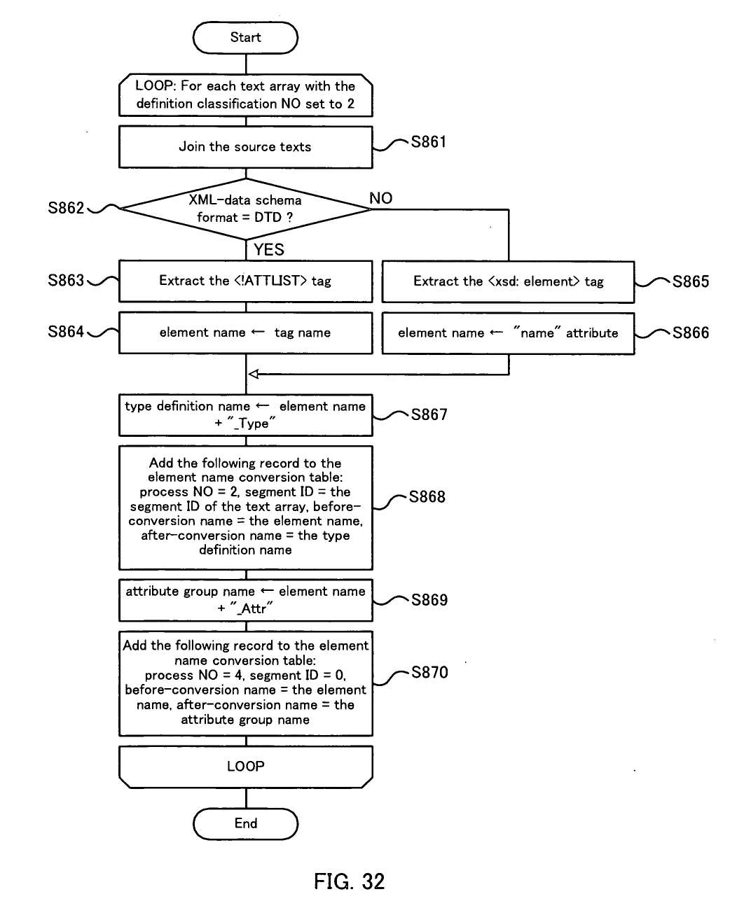

FIG. 32 is a flow chart showing a process of analyzing an element definition. The XML-data schema input unit 14 carries out the following process for each array element whose definition classification NO 441 is set to “2” on the text array 44.

The XML-data schema input unit 14 joins source texts stored in the source list (S861). If the XML-data schema follows the DTD format (S862: YES), the XML-data schema input unit 14 extracts the “<!ATTLIST>” tag from the joined string (S863), and takes the tag name following “ATTLIST” (S864) as the element name. Meanwhile, if the XML-data schema follows the XML Schema format, the XML-data schema input unit 14 extracts the “<xsd: element>” tag (S865), and takes the element name from the “name” attribute in this tag (S866).

The XML-data schema input unit 14 makes the type definition name by joining the element name with “_Type” (S867), and registers a record where “2” is set in the process NO 431, the segment ID 442 of the array element is set in the segment ID 432, and the extracted element name is set in the before-conversion name 433, and the type definition name is set in the after-conversion name 434, on the element name conversion table 43 (S868). In addition, the XML-data schema input unit 14 makes the name of attribute group definition by joining the element name with “_Attr” (S869), and registers a record where “4” is set in the process NO 431, and “0” is set in the segment ID 432, and the extracted element name is set in the before-conversion name, and the group definition name is set in the after-conversion name 434, on the element name conversion table 43 (S870). In this way, on the element name conversion table 43, for each element, the element name and the type definition name are stored being associated each other, and also the element name and the name of attribute group definition are stored being associated each other.

==Analyzing Element/Attribute Type Definition==

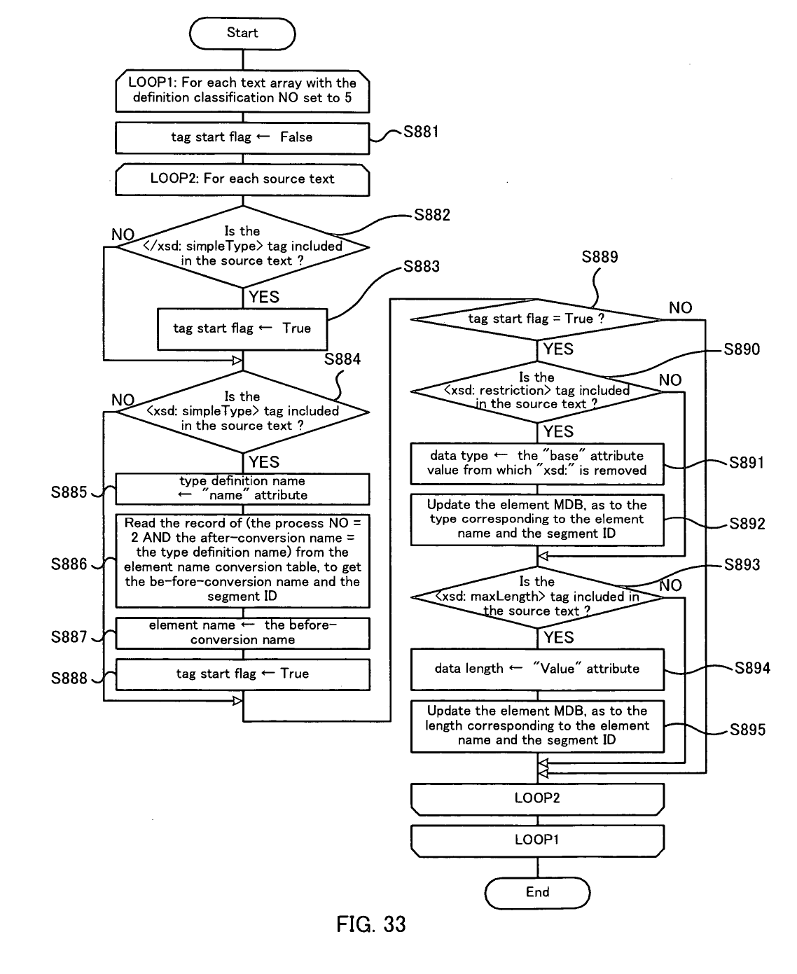

FIG. 33 is a flow chart showing a process of analyzing an element type definition. Incidentally, if the XML-data schema follows the DTD format, type definition is not provided, so that the process of analyzing element or attribute type definition is cut out. Otherwise, the XML-data schema input unit 14 carries out the following process for each array element whose definition classification NO is set to “5” on the text array 44.

The XML-data schema input unit 14 first sets “False” to a tag start flag (S881), and carries out the analyzing process for each of source texts stored on the source list 445 of the array element.

If the end tag “</xsd: simpleType>” is included in the source text (S882: YES), the XML-data schema input unit 14 sets “False” to the tag start flag (S883). Then, if the start tag “<xsd: simpleType>” is included in the source text (S884: YES), the XML-data schema input unit 14 takes the “name” attribute as the type definition name (S885), and finds out the record whose process NO 431 is set to “2” and after-conversion name 434 matches the type definition name, on the element name conversion table 43. Then, the unit 14 reads out the before-conversion name 433 and the segment ID 432 from this record (S886), and takes the read out before-conversion name 433 as the element name (S887), and sets “True” to the tag start flag (S888).

Meanwhile, if the start tag “<xsd: simpleType>” is not included in the source text (S884: NO), the unit 14 checks the current status of the tag start flag. If the tag start flag is set to “False” (S889: NO), the XML-data schema input unit 14 goes back to the step S882 and moves to the next source text.

If the tag start flag is set to “True” (S889: YES), the XML-data schema input unit 14 looks for the “<xsd: restriction>” tag included, and with finding it (S890: YES), removes “xsd:” from the head of the value of the “base” attribute to obtain the data type (S891). Then the unit 14 updates element type in the element management database 31, with respect to the record corresponding to the element name and the segment ID obtained before, based on the obtained data type (S892).

Furthermore, if the “<xsd: maxLength>” tag is included in the source text (S893), the XML-data schema input unit 14 extracts the length from the “value” attribute (S894), then updates element length in the element management database 31, with respect to the record corresponding to the element name and the segment ID obtained before, based on the obtained length (S895).

By carrying out this process for each of the above-mentioned array elements on the text array 44, it is realized to update element type and length in the element management database 31, based on the XML-data schema definition statements.

Meanwhile, the XML-data schema input unit 14 carries out the same process shown in FIG. 33 with respect to attribute data. In this case, array elements whose definition classification NOs are set to “4” on the text array 44 are subject to the steps S881 to S895. On the step S887, the before-conversion name is taken as the attribute name, and on the steps S892 and S895, the attribute management database 32 is updated with respect to attribute type and length of the record corresponding to the obtained attribute name and segment ID.

==Analyzing Attribute Group Definition==

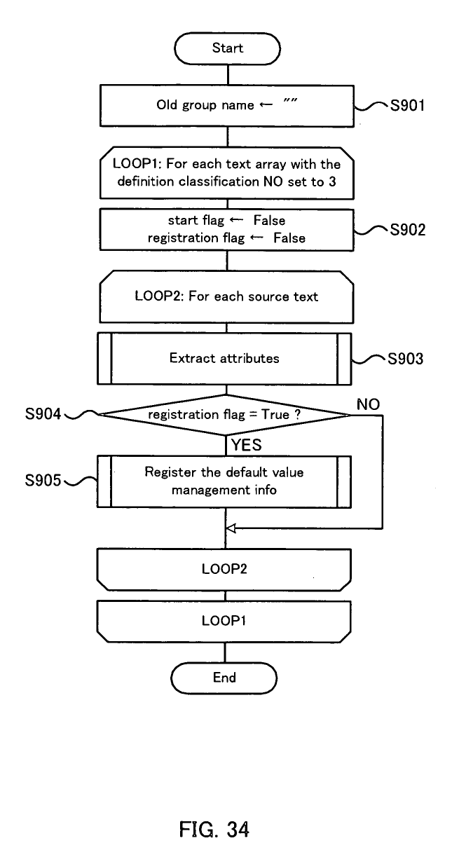

FIG. 34 is a flow chart showing a process of analyzing an attribute group definition. The XML-data schema input unit 14 sets a null string in an OLD group name (S901). Then, the unit 14 carries out the following process for each array element whose definition classification NO is set to “3” on the text array 44.

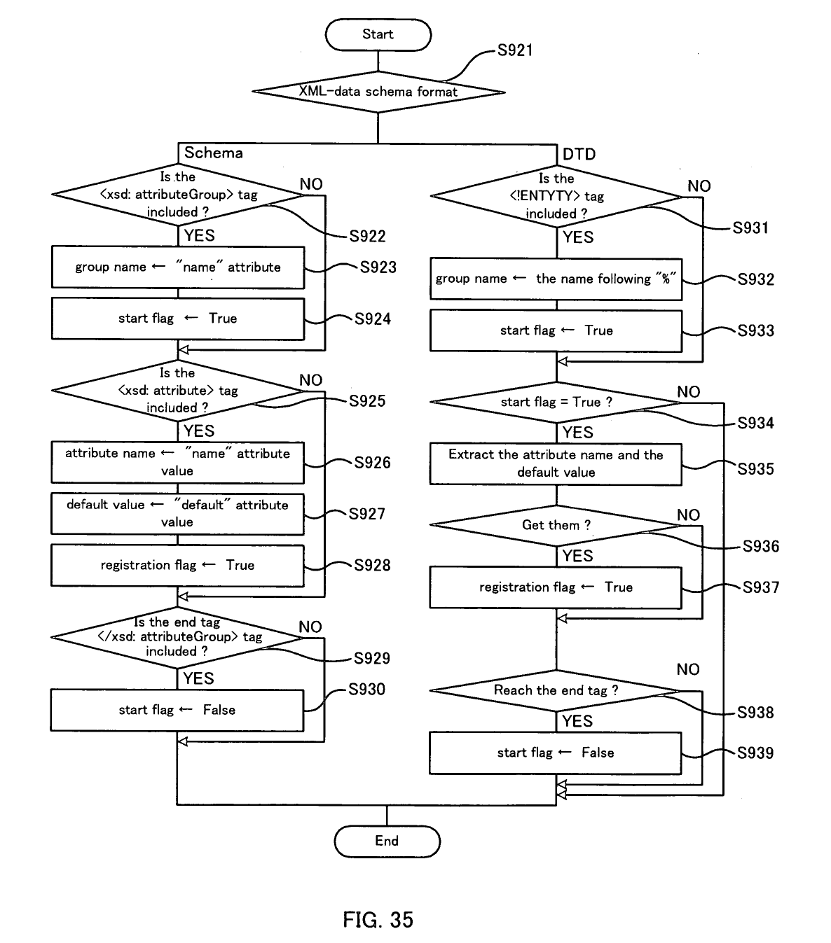

The XML-data schema input unit 14 sets “False” to both of a start flag and a registration flag (S902), then starts a process of extracting an attribute group definition shown in FIG. 35, for each source text included in the source list 445 of the array element (S903).

In the process of extracting an attribute group definition shown in FIG. 35, the XML-data schema input unit 14 first determines whether or not the XML-data schema follows the XML Schema format, and if it does (S921: Schema), then looks for the “<xsd: attributeGroup>” tag. If finding out that tag included (S922: YES), the unit 14 extracts the group name from the “name” attribute (S923) and sets “True” to the start flag (S924). Then, if the “<xsd: attribute>” tag is found included in the source text (S 925: YES), the XML-data schema input unit 14 extracts the attribute name from the “name” attribute (S926) and the default value from the “default” attribute (S927), then sets “True” to the registration flag (S928). When finding the end tag “</xsd:attributeGroup>” in the source text (S929: YES), the XML-data schema input unit 14 sets “False” to the start flag (S930).

Meanwhile, if the XML-data schema follows the DTD format (S921: DTD), the XML-data schema input unit 14 looks for the starting part “<!ENTITY” of the ”<!ENTITY>” tag in the source text. If finding that description included (S931: YES), the unit 14 extracts the name following “%” after “ENTITY” as the group name (S932), then sets “True” to the start flag (S933). The XML-data schema input unit 14, with the start flag set to “True” (S934), finds the attribute name and default value which are described as “attribute name CDATA “default value”” in the source text (S935). If being able to obtain the attribute name and default value (S936: YES), the unit 14 sets “True” to the registration flag (S937). When finding the end character “>” of the tag in the source text (S938: YES), the XML-data schema input unit 14 sets “False” to the start flag (S939).

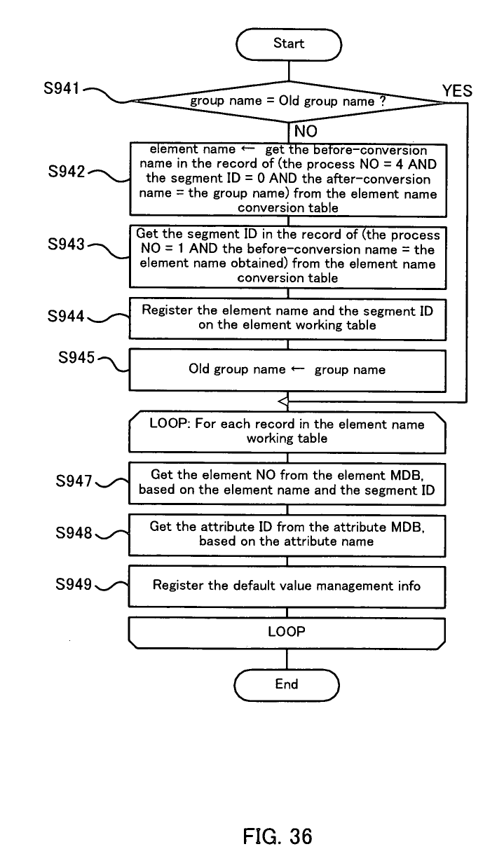

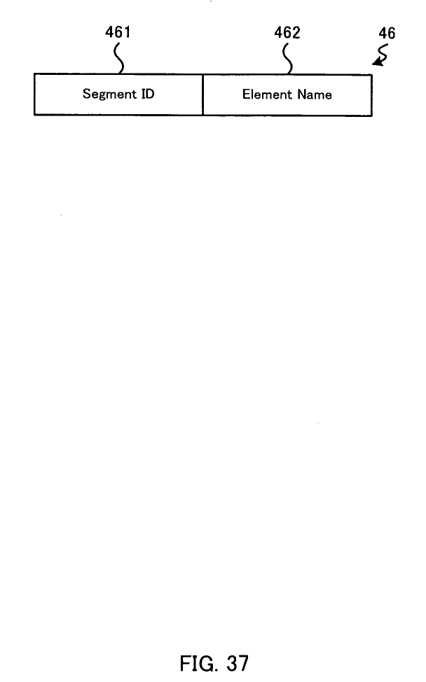

Next, if the registration flag is set to “True” in the process shown in FIG. 35 (S904: YES), the XML-data schema input unit 14 goes to a process of registering default value management information (S905). FIG. 36 is a flow chart showing this registration process. FIG. 37 shows a configuration of a table for use in this process (hereinafter referred to as element name working table 46). As shown in FIG. 37, the element name working table 46 contains an element name 461 and a segment ID 462, associating each other.

In the process of registering default value management information shown in FIG. 36, if the current group name does not match the OLD group name (S941: NO), the XML-data schema input unit 14 looks through the element name conversion table 43 to find out the record whose process NO 431 is set to “4” and whose segment ID 432 is set to “0”, and whose after-conversion name 434 matches the current group name. Then, the unit 14 takes the before-conversion name 433 of this record as the element name (S942). Then, the unit 14 again looks through the element name conversion table 43 to find out the record whose process NO 431 is set to “1” and whose before-conversion name 433 matches the element name read out in the above step. Then the unit 14 obtains the before-conversion name 433 and segment ID 432 of this record (S943). Then, the unit 14 registers a record where the before-conversion name 433 is set in the element name 462 and the segment ID 432 is set in the segment ID 461, on the element name working table 46 (S944). Then the unit 14 sets the group name in the OLD group name (S945).

Finally, for each record in the element name working table 46, the XML-data schema input unit 14 carries out the following steps: obtain the corresponding element NO from the element management database 31, based on the element name 462 and the segment ID 461 (S947); obtain the corresponding attribute ID 321 from the attribute management database 32, based on the attribute name (S948); create the default value management information where the obtained element NO 311 is set in the element NO 331, the obtained attribute ID 321 is set in the attribute ID 332, and the default value is set in the default value 333; register the created information in the default value management database 33 (S949).

In this way, data can be extracted from a XML-data schema definition to be registered in the databases on the information processor 10. In addition, in the information processor of the present embodiment, depth key information which is required to generate a RDB schema can be obtained by reading a XML-data schema. Therefore, it is also possible to define a RDB schema based on a XML-data schema.

Having described the embodiment of the present invention, our aim is to facilitate the understanding of the present invention, and the invention should not be construed limited by any of the details of this description. The present invention can be changed and modified without departing from the scope of the claims, and may include equivalents thereof. For example, in the present embodiment, SQL, XML Schema and DTD are assumed to be used as schema languages. However, other languages may be also used to realize the present invention.

What is claimed is:

1. An information processor, comprising:
an element information storage unit which stores:
an element name to identify each of elements which constitute tree-structured data,
parent-element identification information for use in identifying a parent element which is a parent of the element, and
key information to indicate whether or not the element is a primary key to identify the parent element when the data is managed in a relational database, associating each other;
a XML-data schema generation unit which generates a XML-data schema, describing a schema definition for XML to define a structure of the data, based on the element name and the parent-element identification information; and
a RDB schema generation unit which generates a RDB schema, describing a schema definition for a relational database to define the structure of the data, based on the element name, the parent-element identification information, and the key information.

2. An information processor according to claim 1, wherein:
for each parent element identified by the parent-element identification information, the RDB schema generation unit reads out the element name(s) corresponding to the parent-element identification which identifies the parent element, from the element information storage unit; and
the RDB schema generation unit generates the RDB schema, describing a table definition in which the read out element name(s) are defined as column(s) of the table, and an index definition in which an index is defined on one or more of the read out element name(s) corresponding to the key information which indicates the element is the primary key.

3. An information processor according to claim 1, further comprising:
a user interface where a user inputs the element name, the parent-element identification information, and the key information; and
an element information registration unit which registers the element name, the parent-element identification information, and the key information which are inputted by the user, associating each other, in the element information storage unit.

4. An information processor according to claim 3, further comprising:
an element information output unit which lists up the element names, the parent-element identification information, and the key information stored in the element information storage unit, on the user interface in depth-first order over the tree-structured data.

5. An information processor according to claim 1, wherein:
the element information storage unit stores element identification information, the element name, the parent-element identification information, the key information, and attribute information which indicates attribute(s) belonging to the element, associating each information with others;
the XML-data schema generation unit generates the XML-data schema, describing an attribute definition based on the attribute information; and
the RDB schema generation unit generates the RDB schema, describing a definition of an element table which contains the elements, a definition of an attribute table which contains the attribute values, and a definition of a relation between the element table and the attribute table.

6. An information processor according to claim 1, wherein:
the element information storage unit stores type information specifying a data type of the element, in addition to the element name, the parent-element identification information, and the key information, associating each information with others;
the information processor further comprises a type information storage unit which contains XML data type information indicating a data type in the XML-data schema, and RDB data type information indicating a data type in the relational database schema, associating each other, along with the said type information;
the XML schema generation unit generates the XML-data schema, based on the element name, the parent-element identification information, and the XML data type information corresponding to the type information; and
the RDB schema generation unit generates the RDB schema, based on the element name, the parent-element identification information, the key information, and the RDB data type information corresponding to the type information.

7. An information processor according to claim 1, wherein:
the XML-data schema generation unit generates the XML-data schema in which, the element that is the primary key of the parent element is defined so as to be treated as one of attributes of the parent element, and the key information regarding this element is described as a comment; and
the information processor further comprises:
a XML-data schema input unit which receives an input on the XML-schema data;
an element definition extraction unit which reads out definition of the element along with the described comment, from the received XML-data schema;
a XML-data schema analyzing unit which analyzes the read out definition and comment to extract the element name, the parent-element identification information, and the key information; and
an element information registration unit which registers the element name, the parent-element identification information, and the key information which are extracted, associating each other, in the element information storage unit.

8. An information processor according to claim 1, wherein:
the XML-schema generation unit generates the XML-data schema in accordance with the DTD format or the XML Schema format.

9. A method for creating a schema definition, wherein:
a computer equipped with a CPU and a memory stores:
an element name to identify each of elements which constitute tree-structured data,
parent-element identification information for use in identifying a parent element which is a parent of the element, and
key information to indicate whether or not the element is a primary key to identify the parent element when the data is managed in a relational database, associating each other;
the computer generates a XML-data schema, describing a schema definition for XML to define a structure of the data, based on the element name and the parent-element identification information; and
the computer further generates a RDB schema, describing a schema definition for a relational database to define the structure of the data, based on the element name, the parent-element identification information, and the key information.

10. A program causing a computer equipped with a CPU and a memory to execute:
a step of storing:
an element name to identify each of elements which constitute tree-structured data,
parent-element identification information for use in identifying a parent element which is a parent of the element, and
key information to indicate whether or not the element is a primary key to identify the parent element when the data is managed in a relational database, associating each other;
a step of creating a XML-data schema, describing a schema definition for XML to define a structure of the data, based on the element name and the parent-element identification information; and
a step of creating a RDB schema, describing a schema definition for a relational database to define the structure of the data, based on the element name, the parent-element identification information, and the key information.
